(19) United States
(12) Patent Application Publication
(10) Pub. No.: US 2016/0205358 A1
(43) Pub. Date: Jul. 14, 2016

(54) IMAGING ATTENDEES AT EVENT VENUES

(71) Applicant: FANPICS, LLC, San Diego, CA (US)

(72) Inventor: William Dickinson, San Diego, CA (US)

(21) Appl. No.: 14/915,184

(22) PCT Filed: Aug. 29, 2014
(86) PCT No.: PCT/US14/53598

§ 371 Date: Feb. 26, 2016

Related U.S. Application Data
(60) Provisional application No. 61/871,838, filed on Aug. 29, 2013.
(60) Provisional application No. 61/879,039, filed on Sep. 17, 2013.
(60) Provisional application No. 61/904,393, filed on Nov. 14, 2013.

(51) Int. Cl. H04N 7/18; G06Q 30/02; G06K 9/00

(52) U.S. Cl. CPC H04N 7/188; G06K 9/00778; G06Q 30/0252; G06Q 30/0267

(57) ABSTRACT

Methods, systems, and devices are disclosed for image and/or video acquisition and distribution of individuals at large events. In one aspect, an imaging service system includes image and/or video capture devices including a camera, a multiple-axis positioning system to mechanically secure and pan and tilt the camera, and motion control modules, in which the image and/or video captured devices are arranged in an event venue to capture images and videos of attendees at an event corresponding to an occurrence of the event, a trigger module communicatively coupled to the image and/or video capture devices to send a signal to some or all of the image and/or video capture devices to capture the images and videos based on the occurrence, and one or more computers in communication with the image and/or video capture devices to receive the captured images and videos and provide coordinates to the captured images and videos that correspond to locations in the event venue to associate individuals among the attendees to respective locations in the event venue.

### CLAIM OF PRIORITY

This patent document claims priorities to and benefits of U.S. Provisional Patent Application No. 61/871,838 entitled “IMAGE CAPTURE, PROCESSING, AND DELIVERY AT EVENT VENUES” filed on Aug. 29, 2013, U.S. Provisional Patent Application No. 61/879,039 entitled “IMAGE CAPTURING SYSTEMS AND DEVICES FOR IMAGING ATTENDEES AT EVENT VENUES” filed on Sep. 17, 2013, and U.S. Provisional Patent Application No. 61/904,393 entitled “IMAGE AND VIDEO CAPTURING SYSTEMS AND DEVICES FOR IMAGING AND VIDEOING ATTENDEES AT EVENT VENUES AND PROCESSING THE VIDEOS AND IMAGES FOR THE ATTENDEES” filed on Nov. 14, 2013. The entire content of the above patent applications is incorporated by reference as part of the disclosure of this patent document.

### TECHNICAL FIELD

This patent document relates to systems, devices, and processes that capture images and videos of attendees at sporting events or other group events.

### BACKGROUND

Group events typically bring large crowds of people to one or more event venues for spectating live activities or performances, generally to the enjoyment of the spectator. During various group events, particularly large group events including sports or concerts, the reactions of individuals watching the live performances are highly animated. A photograph of these situations provides a unique and yet highly beneficial and desired memento or keepsake for a spectator, especially if the image and/or video can be captured at a precise moment, tailored to remind the spectator of that specific moment, and easily and rapidly obtained.

### SUMMARY

Techniques, systems, and devices are disclosed for implementing an image and/or video-capture, processing and delivery system to obtain reaction images and videos of individuals at large events including sports games and delivering the obtained reaction images and videos to at least the individuals. In addition, the describes techniques, systems, and devices can provide a crowd sourced security system.

In one aspect, an imaging service system includes image and/or video capture devices arranged in an event venue, at least one of the image and/or video capture devices can capture images and/or videos of locations in the event venue responsive to a triggering signal received during an event. The captured images and/or videos include one or more attendees at the event. The system includes a trigger device communicatively coupled to the image and/or video capture devices to detect an occurrence of a moment during the event that satisfies a threshold. The trigger device can responsive to the detected occurrence of the moment, send the triggering signal to at least one of the image and/or video capture devices to initiate capture of the images and/or videos. The system includes one or more computers in communication with the image and/or video capture devices to process the captured images and/or videos received from the at least one image and/or video capture device to determine coordinates associated with the captured images and/or videos that correspond to the locations in the event venue and to generate a processed image and/or video based on the determined coordinates centered on the corresponding location in the event venue. The locations in the event venue for capturing the images and/or videos are predetermined.

The system can be implemented in various ways to include one or more of the following features. At least one of the image and/or video capture devices can include a camera, one or more motors coupled to the camera to adjust mechanical positions of the camera, and one or more control modules communicatively coupled to the one or more motors to provide control signals to the one or more motors. The trigger device can process feedback from at least one of the camera or the one or more motors. At least one image and/or video capture device can initiate a sequence of image and/or video capture responsive to the triggering signal. The attendees can include fans or spectators at a sporting event. The locations can correspond to labeled seating in the event venue. The image and/or video capture devices can be arranged in the event venue to capture the images and/or videos of the attendees from multiple directions. The image and/or video capture devices can capture a sequence of images and/or videos of the attendees during predetermined time period. The trigger device can include one or more manual trigger mechanisms to be operated by one or more operators to send the triggering signal to capture the images and videos. The trigger device can include at least one automatic trigger mechanism configured to detect a trigger stimulus including at least one of a sound, a decibel level, or a mechanical perturbation, and based on the detected trigger stimulus satisfying a respective threshold, send the triggering signal to capture the images and/or videos.

The method can be implemented in various ways to include one or more of the following features. The one or more computers can process the captured images and/or videos to generate processed images and/or videos of at least one of the attendees based on the determined coordinates corresponding to the at least one attendee. The one or more computers can distribute the generated processed images and/or videos of the at least one of the attendees to a mobile device of the corresponding at least one of the attendees based on information obtained from the corresponding at least one of the attendees. The one or more computers can upload the generated processed images and/or videos of the corresponding at least one of the attendees' user profile associated with a social network. The one or more computers can present the generated processed images and/or videos of the corresponding at least one of the attendees for purchase at a kiosk. The one or more computers can communicatively couple to a security system to determine a security-related incident based on the processed images and/or videos.

In another aspect, a method for capturing an image and/or video of one or more attendees during an event in an event venue for distribution includes capturing, by image and/or video capture devices, a sequence of images and/or videos of locations in the event venue responsive to a triggering signal received during the event. The sequence of images include at least one of the attendees. The method includes assigning labeling information to the captured sequence of images and/or videos. The method includes processing the labeling information assigned sequence of images and/or videos at one or more computers in communication with the image and/or video capture devices. Processing the labeling information assigned sequence of images and/or videos includes mapping, based on the labeling information, the locations to a grid corresponding to predetermined physical locations associated with the event venue to determine coordinates associated with the captured sequence of images and/or videos that correspond to the mapped locations in the event venue. Processing the labeling information assigned sequence of images and/or videos includes determining an image and/or video space containing the at least one of the attendees at a particular location in the event venue based on the coordinates. Processing the labeling information assigned sequence of images and/or videos includes generating processed images and/or videos based on the determined image and/or video space. Processing the labeling information assigned sequence of images and/or videos includes associating meta-data with the generated processed images and/or videos, the meta-data including information representing a moment during the event that generated the triggering signal. The method includes distributing the processed images and/or videos to the at least one attendee.

The method can be implemented in various ways to include one or more of the following features. The predetermined physical positions can include at least one of labeled seating in the event venue or location data of the attendees. The method can include manually generating the triggering signal based on an operator detected moment that satisfies a threshold. The method can include automatically generating the triggering signal based on detection of a sound or mechanical perturbation at the event venue that satisfies a threshold. The sequence of images and/or videos can be captured at a speed of at least two images per second. Capturing the sequence of images and/or videos can include applying a predetermined focus at the locations in the event venue. Generating the processed images and/or videos can include producing a segmented image by cropping at least one of the captured images to a size defined by the image and/or video space. Producing the segmented image can include compensating for overlapping of two or more of the captured images. The method includes presenting a graphical user interface on a mobile device associated with the at least one of the attendee to present the processed images and/or videos of the corresponding at least one of the attendees. The method can include prior to the processing, reviewing the sequence of images and/or videos for at least one of positional calibration, image and/or video quality, or attendee reaction quality, and approving at least one of the reviewed images and/or videos. The labeling information assigned to the images and/or videos of the captured sequence can include a label identifier corresponding to one or more of the following: an identification of the event venue, an identification of the event, an identification of the one or more image and/or video capturing devices, an identification of the moment that generated the triggering signal, and a sequence number of the images of the sequence of images and/or videos.

The method can be implemented in various ways to include one or more of the following features. The method can include prior to the event, capturing a sequence of reference images and/or videos of at least a section of the event venue locations using the image and/or video capturing devices positioned in the event venue. The method can include assigning a reference label to each reference image and/or video of the sequence of reference images and/or videos. The method can include generating a reference image and/or video coordinate space in each of the reference images and videos by mapping reference image and/or video location areas of the captured sequence of reference images and/or videos to corresponding physical locations of the event venue. The method can include generating image and/or video template data for each of the image and/or video location areas associated with each of the reference images and/or videos, the image and/or video template data based on at least a portion of the reference image and/or video coordinate space substantially centered on respective image and/or video location area. Processing the labeling information assigned sequence of images and/or videos include for a given labeling information assigned image and/or video, obtaining the image and/or video template data of the corresponding reference image and/or video based on the labeling information. Processing the labeling information assigned sequence of images and/or video include generating the processed image and/or video for the given labeling information assigned image and/or video based on the reference video template data. Processing the labeling information assigned sequence of images and/or video include distributing the processed image and/or video to at least some of the attendees based on location information of the corresponding at least one attendee obtained from the labeling information. The physical locations of the event venue in the reference images and/or videos can include labeled seating in the event venue.

In another aspect, a method of providing a promotion offer to a mobile device associated with an attendee at an event venue during an event is described. The method includes identifying a physical location of the attendee at the event venue using location data received from at least one of the mobile device associated with the attendee or a check-in site at the event venue that received user input from the attendee. The method includes sending a notification to the mobile device associated with the attendee including the promotion offer from a vendor at a vendor location based on the identified physical location of the attendee. The promotion offer included in the notification is sent to the mobile device inactive and contents of the inactive promotion offer is concealed until activated. The method includes revealing the concealed contents of the promotion offer by displaying the contents on the mobile device associated with the attendee responsive to receiving input activating the promotion offer. The promotion offer has a limited time period of availability after activation.

The method can be implemented in various ways to include one or more of the following features. The notification can include information identifying the vendor and vendor location, and instructions to the attendee to activate the promotion offer at or near the vendor location. Revealing the contents of the promotion offer can include receiving the input activating the promotion offer and identifying the physical location of the attendee as being at or near the vendor location. Identifying the physical location of the attendee as being at or near the vendor location can include receiving a verification by the vendor indicating that the attendee is at or near the vendor location. Revealing the concealed contents of the promotion can be performed exactly one time for a predetermine period of time responsive to the input activating the promotion offer. The concealed contents of the promotion offer can include at least one of an image, video, text, or video. The concealed contents of the promotion offer can include at least one of a price discount on the future purchase, a free product, a free service, or a charitable donation by the vendor with the future purchase. The notification with the promotion offer can be sent during the event corresponding to a specific occurrence of a moment. The concealed contents of the promotion offer can be randomly selected. The concealed contents of the promotion offer can be selected based on attendee preference information. The method can include preventing redemption of the promotion offer until receiving verification of the revealed promotion offer. The received verification can include information received from the vendor.

In another aspect, an image and/or video capturing device is described to capture images and/or videos of attendees of an event at an event venue. The image and/or video capturing device includes a frame structure attached to the infrastructure of the event venue. The image and/or video capturing device includes a camera mechanically supported by the frame structure and including a telephoto lens. The image and/or video capturing device includes a multiple-axis positioning system coupled to the frame structure and the camera to move the camera in pan and tilt movements. The multiple-axis positioning system includes two or more motors two or more pulleys each mechanically coupled to a respective motor of the two or more motors via a belt. Each motor drives the belt attached to the respective pulley to rotate the camera about a pivot. The pulleys are arranged in a triangular-like shape capable of causing an increase of force on the respective belts when driven past a particular pan or tilt range to cause the belts to break as a failsafe precaution to prevent the camera from contacting the infrastructure of the event venue or a portion of the frame structure.

In another aspect, a method of integrating media content with attendee content at an event venue during an event is described. The method includes responsive to a triggering signal associated a triggering moment during the event, capturing a video and/or Graphics Interchange Format (gif) image of attendees at the event during the triggering moment and a video and/or gif image of the triggering moment that the attendees are reacting to, the videos and gif images are captured from image and/or video capture devices selectively arranged in the event venue. The method includes obtaining data associated with the triggering moment during the event. The method includes auto-creating media content that combines the captured videos and/or gif images of the attendees and the triggering moment with the obtained data associated with the triggering moment.

The method can be implemented in various ways to include one or more of the following features. Capturing the videos and/or gif images can be operator controlled. The method can include distributing the auto-created content to at least one of the attendees.

### BRIEF DESCRIPTION OF THE DRAWINGS

FIG. 1A shows a diagram of an exemplary high-level system arrangement and transfer of data and images and videos.

FIG. 1B shows a diagram depicting an exemplary method for image and/or video capture at a venue and imaging processing and delivery of processed images and videos to attendees.

FIG. 2A shows a diagram depicting a further level of detail of exemplary technology methods and how the various pieces of data and images and videos flow through the different components of hardware, software and user interaction.

FIG. 2B shows an exemplary image and/or video flow diagram in an exemplary system of the disclosed technology.

FIG. 3A shows a diagram displaying an exemplary multiple-axis robotic imaging module.

FIG. 3B displays an exemplary multiple-axis robotic imaging module with adjusting movement ranges.

FIG. 4A shows a diagram displaying an exemplary image and/or video-capturing device sequence of an imaging module and how the various hardware and software parts interact to rapidly and accurately capture the positional pre-set images and videos.

FIG. 4B shows a process diagram of an exemplary image and/or video-capturing device sequence.

FIG. 4C shows a process flow diagram of an exemplary image and/or video capture sequence of an exemplary imaging device.

FIG. 5A shows a process flow diagram depicting exemplary positional and image and/or video-capturing device pre-set calibration methods to pre-set the modules image and/or video-capturing device sequence.

FIG. 5B shows a process flow diagram of an exemplary image and/or video positioning calibration and activation process.

FIG. 6 displays robotics associated with the imaging device to manually adjust the zoom and focus on the lens and depress the shutter.

FIG. 7 shows a process flow diagram of an exemplary process performed using image and/or video quality operation software to control which and how many image and/or video moments go to a server for user access.

FIG. 8 is a process flow diagram showing an exemplary process to capture and process reference or calibration images and videos at an event venue.

FIG. 9 is a block diagram showing an exemplary image and/or video indexing software data flow associated with location identification processing.

FIG. 10 displays exemplary angles used by image and/or video-capturing device modules when facing a crowd in a venue.

FIG. 11 displays exemplary vertical vantage points and depth of field of an image and/or video-capturing device modules of a crowd in a venue.

FIG. 12 displays an exemplary imaging modular attachment and detachment mechanism.

FIG. 13 displays an exemplary mirror/reflective system that lights the image and/or video-capturing area.

FIG. 14 displays exemplary advertisements associated with digital image and/or video delivery.

FIG. 15 displays an exemplary constructed final image and/or video with associated event-meta data and advertisement.

FIG. 16 displays exemplary expiring, concealed promotion system and process.

FIG. 17 displays an exemplary user experience of an expiring, concealed promotion system.

FIG. 18A shows a process diagram of an exemplary image capturing, processing, and delivery method of the disclosed technology.

FIG. 18B shows a diagram showing the isolation of images or video captured during an event, from two different camera systems of the disclosed technology, e.g., to obtain the pre-reaction and reaction image or video content of a set group of attendees during an event.

FIG. 19 shows exemplary diagrams depicting examples of the variety of content that forms a processed video that is personalized to the attendee/user.

FIG. 20 shows an exemplary diagram depicting examples of the video-editing interface for an attendee/user.

FIG. 21 shows an exemplary diagram depicting examples of the video or image-capturing device attached to hanging infrastructure perpendicular to the attendees of the event.

FIG. 22 shows an exemplary diagram depicting the integration of the systems captured-content with existing event media coverage and distribution.

FIG. 23 is a diagram showing an exemplary process of using an imaging module to capture videos and/or Graphics Interchange Format images (gifs) of a crowd (e.g., attendee) section as well as images of all the crowd (e.g., attendees) for each triggered event or moment.

FIG. 24 shows exemplary piece of content that can be automatically created for users from the captured content and data from the event venue capture system and back-end processing.

### DETAILED DESCRIPTION

Exciting moments during events such as sports and concerts evoke emotional reactions from those in attendance. To take all of the images and videos from these short reaction periods and seamlessly deliver them to users is of high value to those in attendance. This is because these images and videos are of candid emotional reactions. The content can be further personalized and even associated with specific contextualization to each captured moment. Attendees enter their seat number/ticket code into a mobile application or website and all of their candid images and videos from the game are made available to them. These images and videos provide social media, sponsorship and spectator engagement opportunities for both end-user consumers and businesses.

In some aspects, techniques, systems, and devices are disclosed for implementing a rapid image and/or video-capture, preparation and delivery system to obtain the reaction images and videos of attendees at certain group events, e.g., large events including sports games, concerts, etc., and to provide a crowd sourced security system.

The disclosed technology can capture high-resolution images and videos of attendees' emotional reactions, in the short periods of time after various moments during an event. For example, a sporting event in a sports stadium can include memorable moments such as a goal, touchdown, dunk, homerun, red card, anything that elicit emotional reactions from the attendees. Attendees at the event are sent images and videos of themselves captured during the moments to their mobile device and/or web profile, and the images and videos can be made accessible during or after the event. There are various technical challenges to capture and deliver these images and videos, requiring custom hardware, software and processes. When combined this produces a system that can be deployed and used at various venues and events.

In some implementations of the disclosed technology, the event venue system hardware can include a series of imaging modules that include a multiple-axis robotic mechanism and an imaging device. A trigger module can communicate with any or all of the imaging-modules and the software controlling the imaging modules. Exemplary software for controlling individual imaging-module can include an imaging sequence control and an imaging device robotics control. Exemplary software for controlling the venue system hardware can include positional and image and/or video-capturing device calibration, image and/or video transfer and image and/or video operation software. The exemplary imaging modules can be remotely controlled and monitored and each venue's system can include additional calibration software. In implementations, the images and videos can be processed to identify attendees' locations and can be manipulated (e.g., cropped) so their specific digital images and videos can be delivered to them. In some examples, to access the images and videos, each attendee can input data such as a seat number or a unique ticket code.

Exemplary configurations in which the imaging modules are attached and detached from the venue and the specific imaging module positioning, angles and arrangement within the venue to capture high-quality images and videos are disclosed. In some implementations, captured images and videos can be constructed in a particular manner, assigned with specific event meta-data and sponsored branding when attendees wish to share them. For example, the disclosed imaging systems, devices, and methods can be used for capturing attendees' emotions including controlling the timing and speed of image and/or video-capture for various implementations.

In some aspects, a mobile expiring, concealed promotion feature can be included to provide a unique method of engaging with users.

In this patent document, section headings are used in the description only for case of comprehension and do not limit in any way the scope of the disclosed subject matter.

I. System Overview

Multiple image and/or video-capturing modules are installed at a venue to take high-resolution images and videos (e.g., above 50,000 pixels per person) of the crowd during the short (e.g., 0-20 seconds) emotional reaction periods, after an important or memorable moment in a game, concert, speech etc. After each moment, the imaging modules are rapidly (e.g., 0.1-1 second) triggered and all of the imaging modules rapidly (e.g., 0.5-1 second per image and/or video captured) capture images and videos of pre-defined locations/angles that the imaging modules are calibrated to operate. As the technology is designed to capture reaction images and videos, both the trigger and speed of capture are accurately performed.

Captured images and videos are labeled and uploaded to a server and are indexed and mapped to specific locations, such as seat numbers, seating position and crowd positions of attendees in the crowd or stands using a predefined method. Each captured image and/or video is then tied to specific meta-data associated with the triggered moment in the event; the meta-data can include the sports teams playing, the score, scorer, player name, or other identifying information.

Attendees communicate with a website or mobile application and enter attendee information to retrieve or get pushed their images and videos from the event. This information could be the venue, fixture, seat numberilocation or geolocation data, or a unique code. The described system can provide quick and easy access to individual attendee's images and videos.

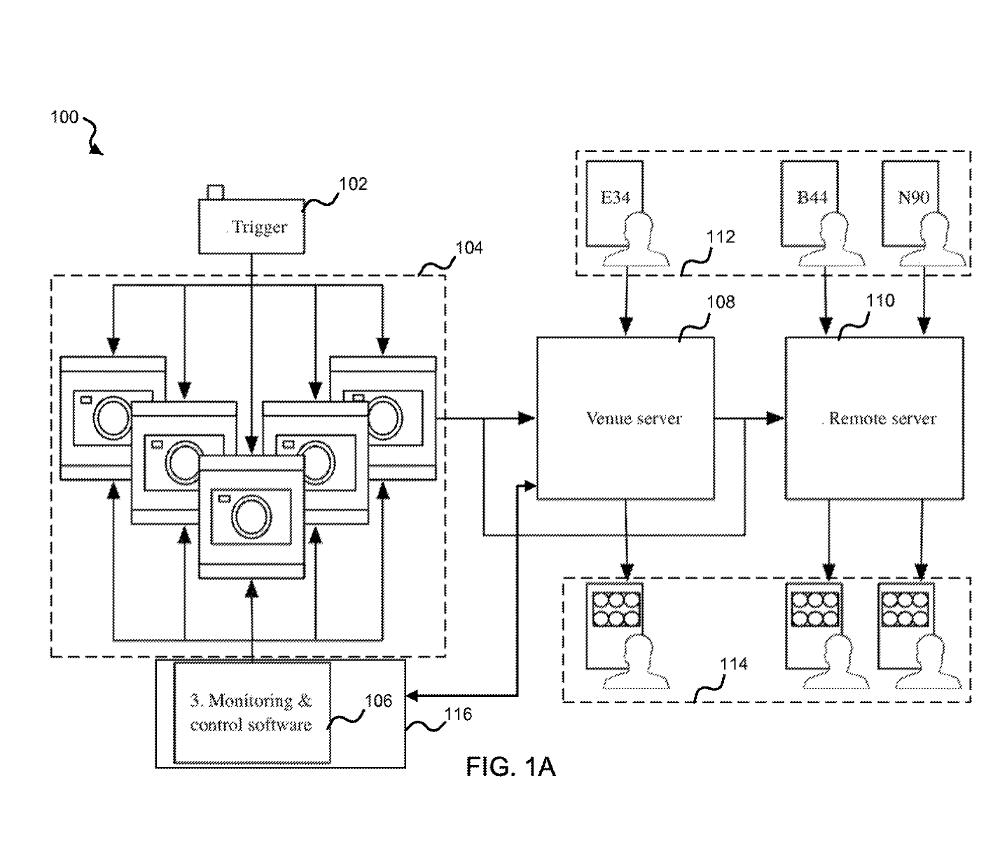

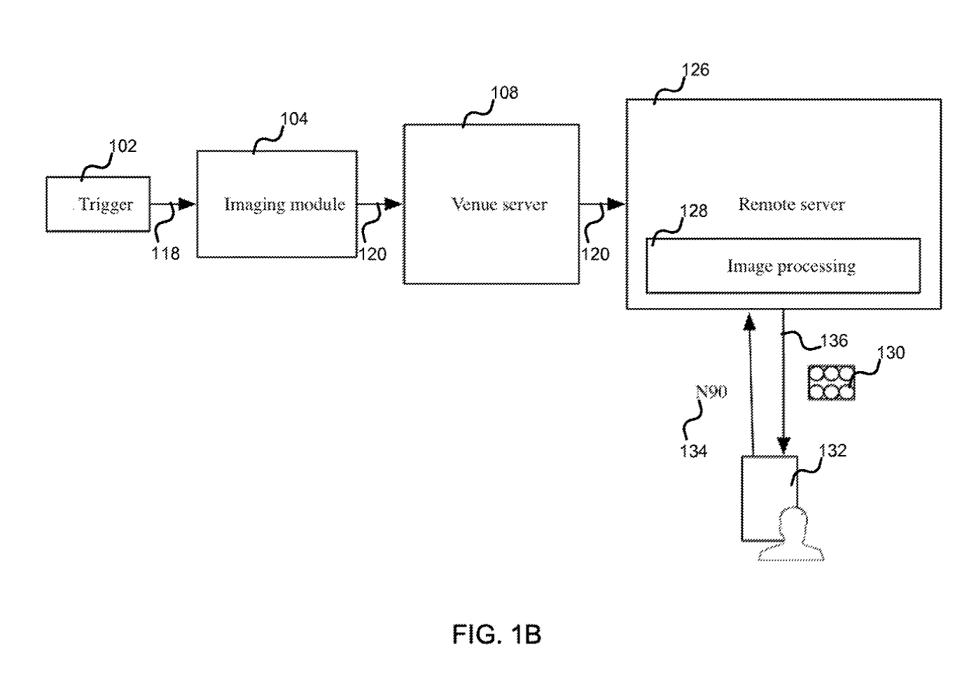

FIG. 1A shows a high-level block diagram of an exemplary system 100 of the disclosed technology for the capture, processing, and transfer of data, images and videos to attendee users. Various components of the exemplary system are highlighted here, e.g., including the venue hardware and software, the remote server, and the user data and image and/or video interaction. For example, in some implementations of the system 100, after a moment in the event occurs, the trigger module 102 of the system 100 is engaged and sends a signal to some or all of the imaging modules 104 of the system 100, which can begin the image and/or video capture sequence. The captured images and videos can be sent to either the venue server 108 of the system 100 for validation and upload to a remote server 110 of the system 100 or directly from the imaging modules 104 to the remote server 110. Attendee users 112 operating user devices can enter information such as a seat number to the remote server so that their specific images and videos can be sent to the attendee users' devices 114 or web profiles in the cloud. Monitoring & control software 106 of the system 100 can enable the imaging modules 104 to be calibrated and controlled remotely. The monitoring & control software 106 can be stored on a server 116 that can also act as a backup server that automatically takes over from the venue server 108 due to a fault.

FIG. 1B shows a data flow diagram depicting data flow in an exemplary method for performing overall image and/or video capture at a venue, followed by image and/or video processing of the captured images and videos and delivery of the processed image and/or video to individuals attendees at the event. As shown in FIG. 1B, the trigger module 102 is triggered during a specific moment, for example, to capture attendees emotional reaction at the venue. The trigger module 102 once triggered sends a trigger signal 118 to at least one of the imaging modules 104 to initiate capture of an image and/or video or series of images and/or videos (for example, of attendees) at the venue at the moment. The captured images and/or videos 120 are transferred from the imaging modules 104 to one or more computers (e.g., venue server) 108, which can be uploaded to other computers (e.g., remote server) 126. In some implementations, the captured images and/or videos are processed using an image processing module 128, so that individual images and/or videos 136 can be sent to attendees' devices 130 at the venue 132, e.g., after they have provided their location information 134.

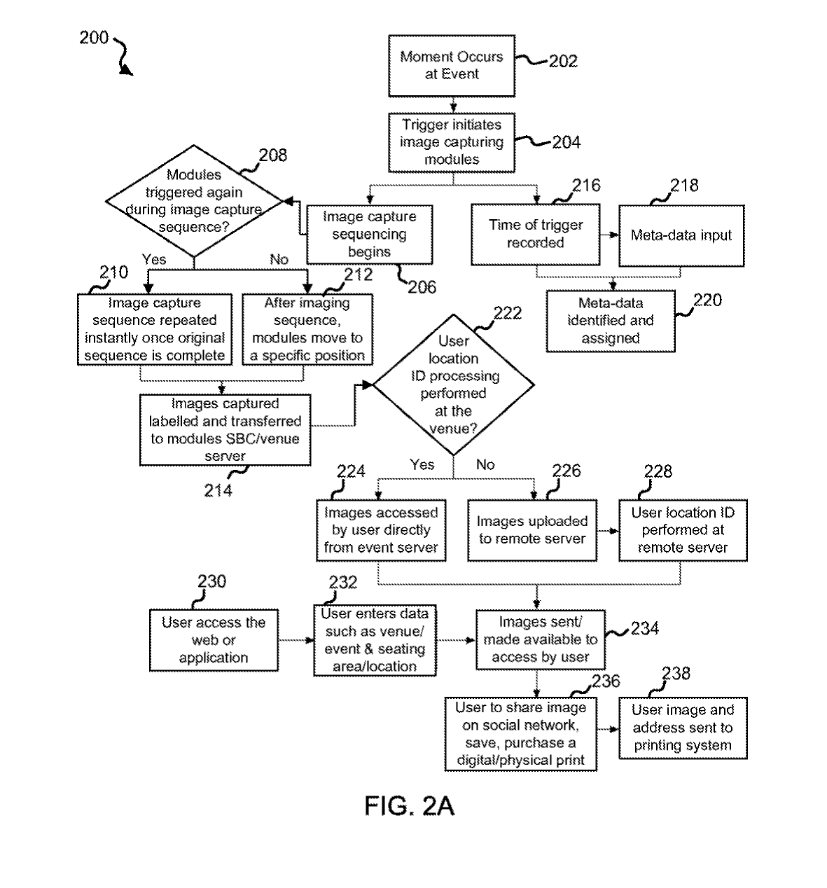

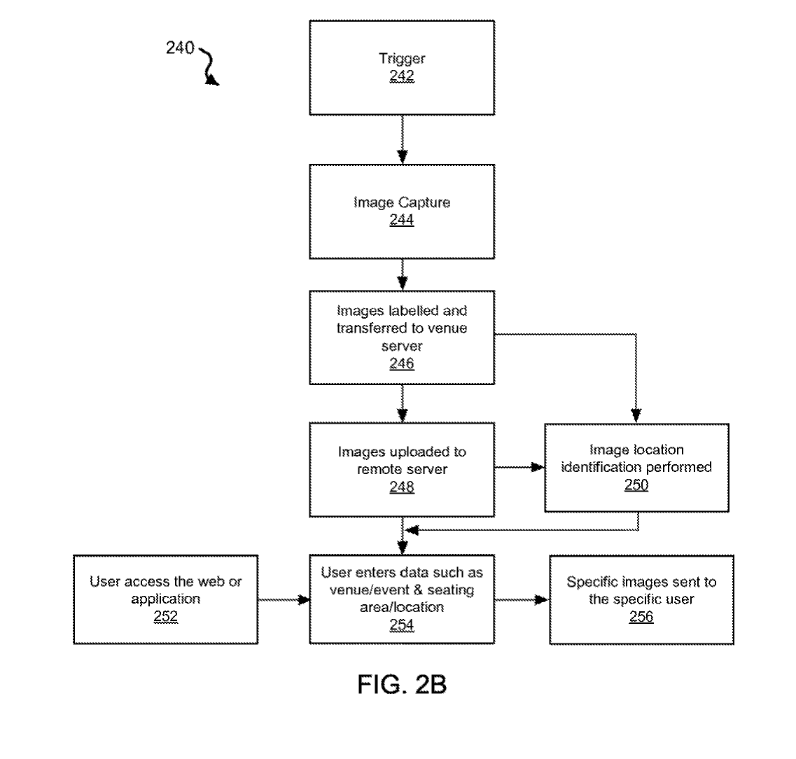

FIG. 2A shows a process flow diagram of an exemplary method 200 to capture, process, and deliver an image and/or video to a user of an event. For example, the process 200 shows flow of information through the system 100. A memorable ‘moment’ occurs (202) evoking the attendees to display an animated emotional reaction to initiate a trigger (204) which starts the imaging modules to perform a pre-calibrated image and/or video-capturing sequence (206). When the imaging modules are signaled to repeat image and/or video-capturing sequence by another trigger during an on-going sequence (208), another pre-calibrated image and/or video capturing sequence is performed after the on-going sequence is completed (210). When the imaging modules are not signaled to repeat image and/or video-capturing sequence by another triggered during an on-going sequence, the imaging module moves to a pre-designated position and wait to be retriggered for the next ‘moment’ (212). In some implementations, the imaging module software and/or system software can prevent the imaging modules from being retriggered during an on-going image and/or video capture sequence and indicate that a capture sequence is in progress. When prevented from retriggering as described, a double trigger on the same moment would have to be initiated again once the on-going sequence is completed.

The images and/or videos captured during a captured sequence from each imaging module are labeled (214) and transferred to the imaging module's single board computer (SBC) and venue server. Responsive to the trigger initiating image and/or video capture sequence, the time of the trigger is recorded (216) and meta-data relating to the triggering contextual ‘moment’ is either input manually by the operator (218) or the timing associated with the meta-data corresponds with the nearest trigger time to automatically be assigned by a 3^{rd} party data provider or by an internal database (220).

The images and videos have pre-defined indexing to the crowds' specific locations calibrated with the venue, such as seat numbers. When attendee user location identification processing occurs at the venue server (222), the labeled images are available for access by attendee users directly from the event server (224). When the user location identification processing does not occur on the venue server, the labeled images and/or videos are uploaded to a remote server (226) for processing the uploaded images and/or videos at the remote server (228).

Attendee users can access a website or mobile application (230) and enter data, such as the venue, their location, etc. (232). Entering the data allows attendee users' images and videos to be located and sent to their devices or web profiles or made available to access from the remote server of the event server (234). Once the attendee users have obtained their images and/or videos the attendee users can perform a series of actions built within the accessed website or application (236) to share the images and/or videos directly to various social networks, save the images and/or videos, purchase a digital copy or order a physical print (for images). The purchase of a digital copy can involve the images and/or videos to be re-uploaded without any image and/or video compression. For a physical print of the images, the images and delivery address of the requesting attendee user is sent to the printing system (238). Also, images and/or videos can be purchased at the venue from a kiosk, for example.

FIG. 2B shows an exemplary image and/or video data flow diagram in an exemplary system of the disclosed technology. As shown in FIG. 2B, after the triggering (242) of image and/or video capture devices (e.g., imaging modules) to capture images and/or videos, and after the images and/or videos have been captured (244) by the image and/or video capture devices, the captured images and/or videos can be labeled and transferred to one or more computers. e.g., including a server. In some examples, the images and videos are labeled and transferred to a venue server (246) and then uploaded to a remote server (248). At the remote server, the uploaded images and/or videos can be processed to produce processed images and/or videos based on specific locations in the venue. In some examples, the image and/or video processing can be performed on the venue server (250). Attendee users can provide to the venue server data including the venue, the event, their seating number, etc. (254), for example, by using a web or mobile application (252). The data provided by the attendee user can be used to locate the specific images and/or videos assigned to each attendee location during or after the image and/or video processing (250). The exemplary location-specific processed images and/or videos can be sent to the user (256).

II. Triggering of Imaging Modules for Image/Video Capturing

The triggering of the imagine modules for capturing images/videos can be initiated by a variety of methods. One way to trigger the imaging modules is by an operator(s) watching the event and/or the crowd who determines when a sufficient ‘moment’ occurs. The trigger can be a radio signaled device or a mobile or computer device connected to the venues network either hardwired or through wireless access. Multiple triggers can be used at the same venue with multiple operators to ensure capturing images or videos of a ‘moment’ is not missed.

In addition to a manual triggering system, the imaging modules can also be triggered using an automated system. For example, movement-monitoring sensors on sections of the crowd can initiate the trigger when the crowd movement satisfies a threshold movement level to justify an event as a triggering ‘moment’. An automated triggering system uses pre-calibration to gauge the level of movement to a suitable threshold level. Another automated method is to trigger the imaging modules based on sound or decibel levels that satisfies a predetermined threshold level at the venue. During a ‘moment’ the venue volume will increase and when the volume satisfies a pre-calibrated threshold level then the triggers can be initiated. Yet another automated method is to connect the trigger module to pre-installed monitoring systems that can map a ‘moment’ to a detectable event such as goal-line technology detecting a goal, lighting etc. Multiple triggering methods/systems can also be combined together to ensure a ‘moment’ is not missed.

After the trigger has been released, a period of time (e.g., 4-10 seconds) exists in which sequences of images and/or videos are being captured by the imaging modules. When another trigger is initiated during the on-going image and/or video capture period, the image and/or video capture sequence continues as usual but once completed, the imaging modules can instantly retrigger to recapture the crowd (i.e., image and/or video capture sequence is repeated). The retriggering process is designed for particularly large ‘moments’ in which the crowds' reaction is prolonged. If multiple operators are using multiple triggers, then the retrigger only occurs when one person triggers twice.

Alternatively, during an on-going image and/or video capture sequence, a retriggering signal is ignored or prevented until the on-going image and/or video capture sequence is completed. In other words, the triggering module cannot reinitiate during an on-going image and/or video capture sequence. The trigger can have some form of visual timer (image and/or video sequence time period) to show the operator when images and videos are still being taken, to determine when and if to retrigger based on the crowd still being in a reaction phase.

For all triggering methods used, all imaging modules can be hardwired with network cables that can rapidly transfer the trigger signal to the imaging modules. All trigger times can be saved to the sequence of images and/or videos captured as the trigger time data can be used to correspond with meta-data on what caused a given ‘moment’.

III. Hardware & Software: Specific Examples

An image and/or video-capturing device suitable for the disclosed system can include an imaging sensor for capturing images or videos and a lens or lens system for collecting light from a scene onto the imaging sensor. Such a device can be a digital SLR camera, a digital camera, a device with custom imaging components or a stripped down version of a camera unit, which only includes certain features for image and/or video capture.

The image and/or video-capturing device can be secured to a servo controlled multiple-axis (pan & tilt) mechanism designed to rapidly accelerate and stop through a sequence of images and videos captures. The servo selection, gear reduction and structure of the device can accommodate a wide range of imaging capturing devices, keeping the center of gravity of each at the intersection of the mechanism's multiple axis.

The image and/or video-capturing device includes digital processing circuitry and in-device software that perform various functions, including, e.g., digital control of imaging capture of images or video, in-device digital processing on captured images or videos and other digital functions.

IV. Multiple-Axis Robotic Mechanism & Module Components

IV.1. Multiple-Axis Robotic Mechanism

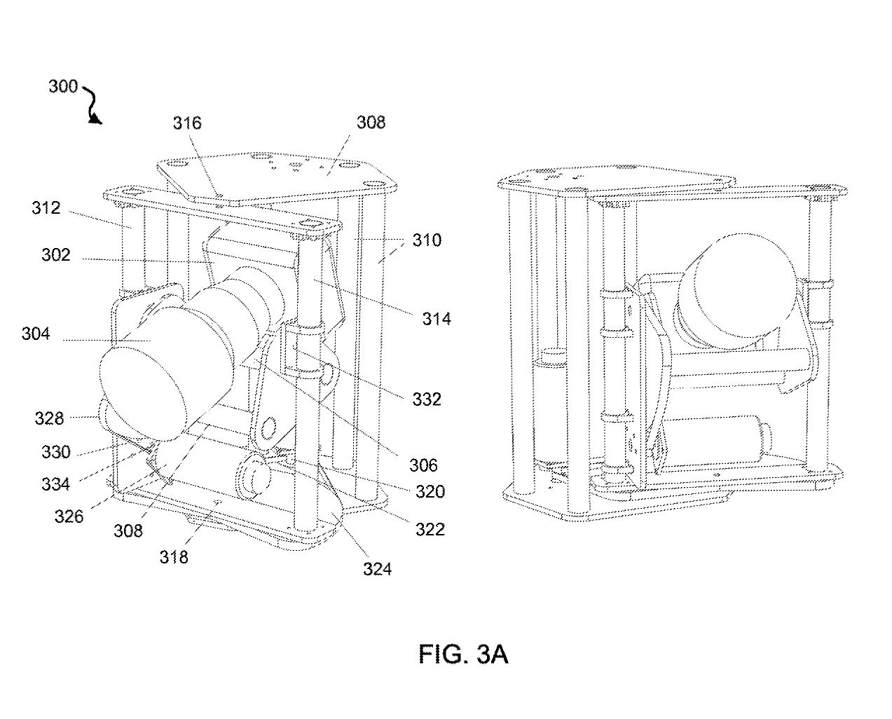

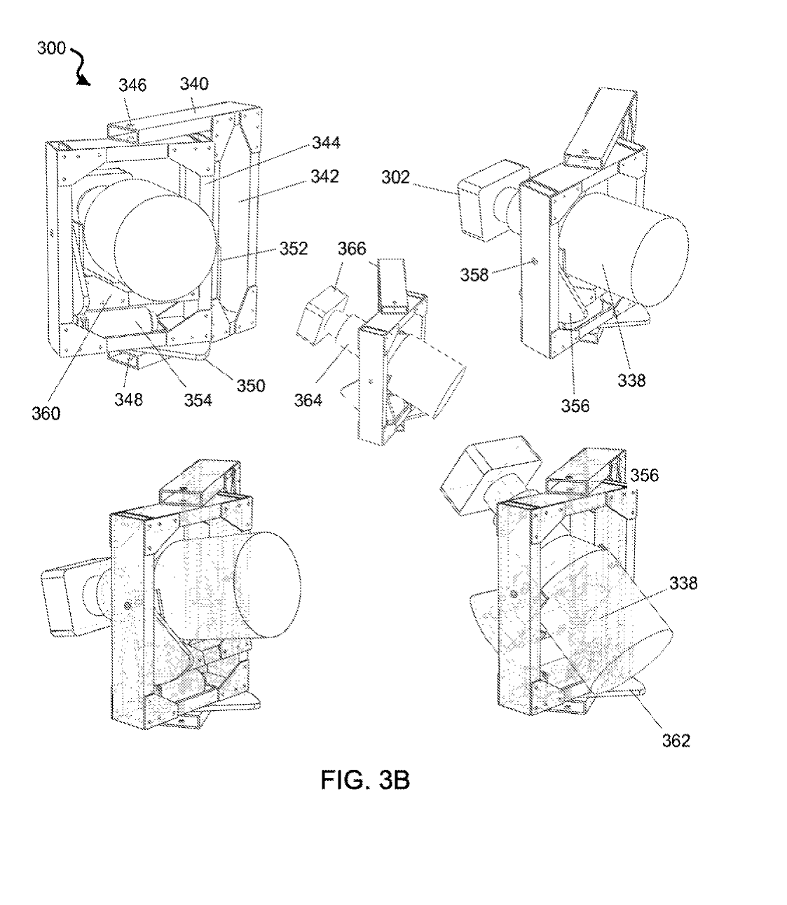

Each imaging module includes a multiple-axis robotic mechanism that rapidly adjusts the image and/or video-capturing device angle to capture images and videos of different sections of a crowd. FIG. 3 shows an exemplary imaging system 300 with an image and/or video capture device 302 attached to a multiple-axis robotic mechanism such as a pan and tilt system. The image and/or video-capturing device 302 and lens 304, are securely held by the multiple-axis robotic mechanism, using parts 306 and/or 308. The imaging module 300 can be secured against a fixed piece of venue infrastructure, or a bracket, which is attached to the venue infrastructure, by the structures 308 and/or 310. The parts 312 and 314 are the vertical beams of a frame, which pans with the image and/or video-capturing device and lens, secured to the multiple-axis robotic mechanism/module with bearings at points 316 and 318. This ensures the weight of the image and/or video-capturing device, lens and secondary motor, rotate around their center of gravity, reducing the torque forces of the panning movement. A servomotor at the back of the module rotates the pulley 320 to drive the belt 322, to rotate the pulley 324, which is secured to the panning frame, housing the image and/or video-capturing device, lens and secondary servomotor 326. This serves as a gear reduction to increase the torque of the pan. Idlers keep the belt sufficiently engaged with pulley 320 and also keep the belt constrained to pulley 324, ensuring a strong correlation between the pulley angle and pan angle. The secondary servomotor 326, is used to tilt the pulley 328 using the belt 330. This tilts the image and/or video-capturing device and lens, which is attached to parts 306 and 308, again utilizing the pulley 328 as a gear reduction and an offset allowing the center of gravity of the image and/or video-capturing device to mount in line with the tilt axis. On both the pan and tilt pulleys, 328 and 324, only part of the full circular gear is formed, as there is only a limited pan and tilt degree required, in order to reduce the footprint of the multiple-axis robotic mechanism and provide additional mechanical safety stops.

This can also be implemented by switching the pan with the tilt set up to ensure the panning mechanism only moves the image and/or video-capturing device and lens and the tilt moves the image and/or video-capturing device and lens plus one of the motors. This is because there will be more panning movements than tilting ones, which reduces the moving weight of the most performed action.

For example, the exemplary multiple-axis robotic mechanism can provide a panning range of 180° and a titling range of 60°. For example, the motors ensure that the multiple-axis robotic mechanism has revolution precision below 0.5° and is able to move 10° in less than 0.25 seconds and stabilize in 0.1 seconds, on both axes simultaneously. The servomotors provide power to push back to ensure the multiple-axis robotic mechanism rapidly stops and stabilize the multiple axis robotic mechanism at a specific rotation point. Optical encoders built into the motors ensure these specific points are driven correctly.

The multiple-axis robotic mechanism has an adjustable connection point to the image and/or video-capturing device and lens to ensure different sized and weighted image and/or video-capturing devices and lens can be replaced and that the image and/or video-capturing device and lens remain panning and tilting along the center of gravity.

The above described multiple-axis robotic mechanism can accommodate a range of image and/or video capturing devices and lenses. For large telephoto lenses (over 300 mm lenses) the mechanism requires less movement range given the relatively larger change in subject angle for the same movement degree, as the lens is zoomed further into a subject. In the previous design shown in FIG. 3A, the image and/or video capturing device pans and tilts inside the structure 308, 310, 332 and 334, when using a telephoto lens the depth of the structure 308 and 310 would need to be deeper and because of the reduced range, now only panning 50° and a tilting 30°, the unit would take up more volume and area footprint than required, for both smaller and larger lens scenarios when trying to accommodate both in this design.

An alternative design can accommodate the large lens with reduced panning and smaller lens with a wider range of panning, and take up less volume and area footprint. FIG. 3B shows an exemplary imaging module 336 with a multiple-axis robotic mechanism that accommodates large lens with reduced panning and smaller lens with wider range of panning. The image and/or video-capturing device 302, and telephoto lens 338, is attached to the multiple-axis robotic mechanism. The structure 340 and 342 is attached to the venue infrastructure. This structure is attached to the frame 344 in which the image and/or video-capturing device and lens is held. This frame pans around the pivots 346 and 348, the frame being attached to the pulley 350 and driven by a belt which is attached to the motor's pulley 352. The motor 354 drives the belt attached to the pulley 356, which pivots at point 358 to tilt the structure 360, which is attached to the imaging device and lens. The pulleys 362 and 356 have a triangular shape to increase the force on the belt if driven past a certain pan or tilt range. This will cause the belts to break before the frame 344 is panned too far to hit the imaging-device and lens against structure 344 and the same with the tilt and hitting the imaging-device and lens against the frame.

The benefit of this exemplary design is that is allows a smaller lens to have sufficient pan and tilting range as it clears the structure 342 when panning and frame 344 when tilting. For a bigger lens 364, the range of movement is reduced so that the imaging-device and lens do not contact the frame 366.

Alternative designs using different structure set-ups, motors, axis points, gears etc. can also be used.

In one exemplary embodiment, an image and/or video capturing device to capture images and videos of attendees of an event at an event venue includes a frame structure attached to the infrastructure of the event venue; a camera mechanically supported by the frame structure and including a telephoto lens; and a multiple-axis positioning system coupled to the frame structure and the camera to move the camera in pan and tilt movements. The multiple-axis positioning system includes two or more motor, and two or more pulleys each mechanically coupled to a respective motor of the two or more motor via a belt, in which each motor drives the belt attached to the respective pulley to rotate the camera about a pivot, and in which the pulleys are configured in a triangular-like shape capable of causing an increase of force on the respective belts if driven past a particular pan or tilt range, thereby causing the belts to break as a failsafe precaution to prevent the camera from contacting the infrastructure of the event venue or a portion of the frame structure.

IV.2. Module

An exemplary module of the disclosed technology can include the multiple-axis robotic mechanism, housing the image and/or video-capturing device, lens, motors, and other components. These components can include a driver, which controls the multiple-axis robotic mechanism movement, a microcontroller, a single board computer (SBC), which can save data and adjust the image and/or video-capturing device settings, an accelerometer, which can provide feedback movement information and batteries, which can power the module/multiple-axis robotic mechanism. These batteries can be continually charged to ensure no power lapses impact the calibration or ability to trigger the image and/or video-capture sequence, ensuring reliability. Both power and data connection can be hardwired to the module.

If the module is installed outside, weather may damage the optics, robotics and electronic components. A casing that prevents water damage and doesn't impair the movement mechanisms or affect the image and/or video quality is used. This could be in the form of a cover, which overhangs the module, in an umbrella type concept. Or this could be a more complex design with a flexible, waterproof material covering the front of the module, which moves with the multiple-axis robotic mechanism and is attached to a transparent screen covering the lens.

V. Image and/or Video-Capture Sequence

Disclosed are exemplary pre-calibrated image and/or video-capture sequence methods to ensure that the images and videos are captured at a high quality, speed, and accuracy. Implementation of the exemplary image and/or video-capture sequence methods can allow the image and/or video-capturing device module/multiple-axis robotic mechanism to burst through a series of set positions at a high-speed acquiring the maximum amount of shots without affecting the image and/or video quality.

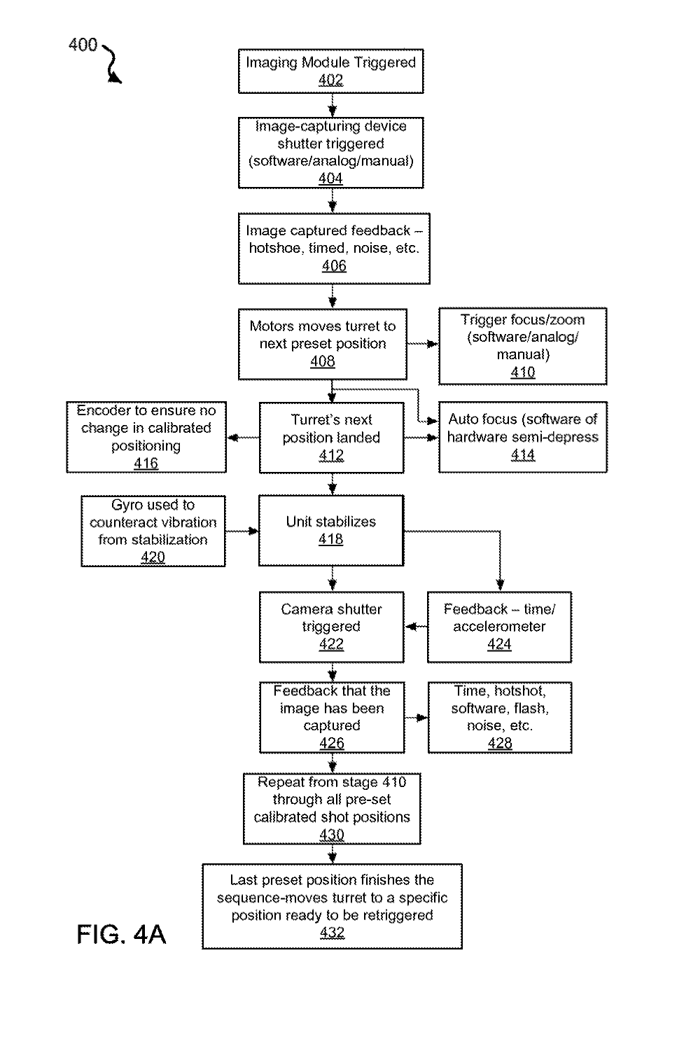

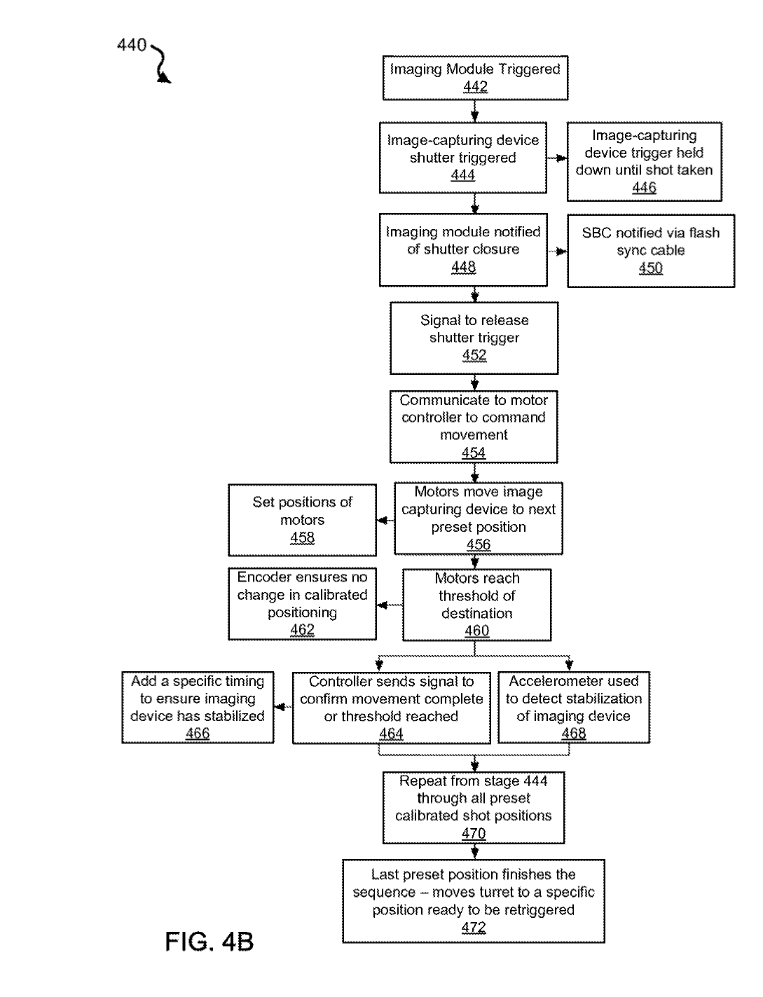

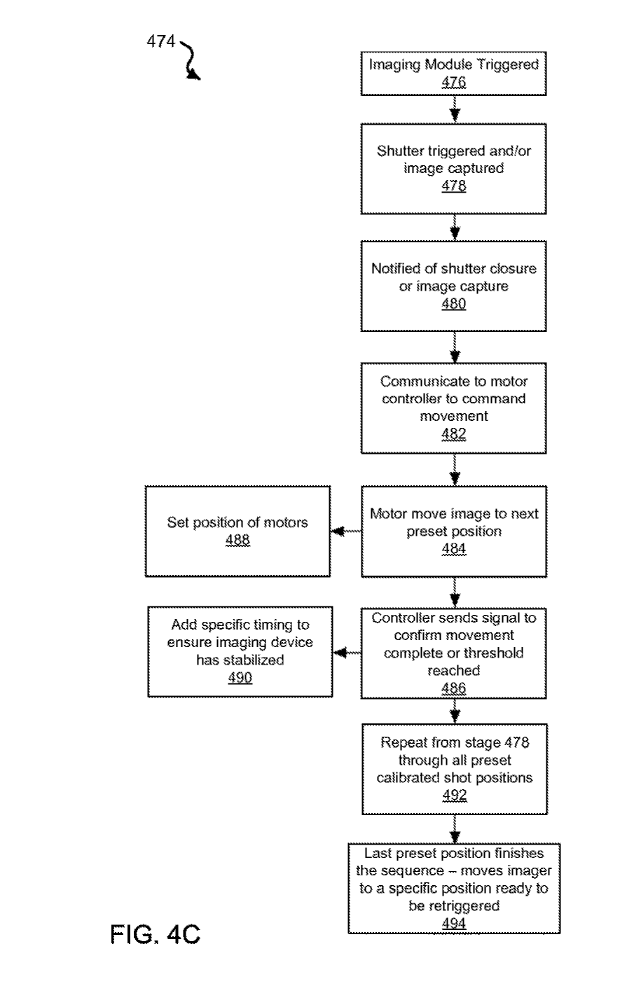

FIG. 4A shows a process flow diagram of an exemplary process 400 for capturing image and/or video sequence that can be implemented by the imaging modules of the system 100, e.g., as part of the process 200. When the imaging module is triggered (402) the controller activates the image and/or video-capturing devices' shutter (404). The shutter could be triggered using software, a wired analog input or a hardware piece that depresses the shutter, shown in FIG. SA, part 8 for example. Closing of the shutter provides feedback data that the image and/or video has been captured (406). The feedback data could be sensed via a hotshoe, based on a timer from when the shutter was triggered or by software or an analog signal that highlights an image and/or video has been taken. There can also be feedback to and from the driver, notifying the system when the images and videos are taken and when the sequence is in activation.

The controller then activates the multiple-axis robotic mechanism motors to move the imaging and video capturing device to the next preset position (408). The position is pre-set with specific co-ordinates for the motors to drive it to with a high level of accuracy, below 0.50 in resolution on both the pan and tilt axis on the multiple-axis robotic mechanism. When focus and zoom adjustments are needed for the next preset position, the focus and zoom can be triggered during the movement periods of the multiple-axis robotic mechanism. Focus and zoom can be triggered by software or hardware as shown FIG. SA. Triggering the focus and zoom during the movement period can reduce shooting delays by performing the adjustments when the imaging device is in between shooting periods, adjusting the settings per shot. Once the multiple-axis robotic mechanism has moved the image and/or video-capturing device to its next position (412) an encoder can be used to verify that no change in calibrated position has occurred (416). When the image and/or video-capturing devices' automatic focus system is activated, either by software or hardware, to semi-depress the shutter button, the auto-focusing period can start (414). The autofocus period can begin before the image and/or video-capturing device has stabilized, reducing the shooting delay. As the image and/or video capture device is stabilizing (418), a gyroscope can be used to counteract the vibration (420), also reducing shooting delay. Once the image and/or video-capturing device stabilizes (418), movement feedback is given (424) which could be via a timer, started from when the movement was triggered or an accelerometer, which measures when the movement has subsided. This movement feedback could also be from the driver or controller, which can identify when the unit has stopped moving. The image and/or video-capturing device shutter is then triggered (422) and again provide feedback (426)/(428) that the shot has been taken as before (406). This is then repeated (430) from stage (410) and this continues through the entire pre-set sequence of shots stopping at all of the pre-calibrated positions.

At the end of the exemplary image and/or video-capture sequence method 400 and after the last position's image and/or video has been captured the multiple-axis robotic mechanism then moves to a new specific, pre-calibrated starting position (432). Instead of the multiple-axis robotic mechanism moving back to the original starting position for the sequence, the multiple-axis robotic mechanism can start at a new position for the next moment capture. For example if the movement positions were panning from 402-420, instead of returning to position 402, ready to be re-triggered, the multiple-axis robotic mechanism now starts at position 406 and continues through from 406-420 and back through 402-406. The reason for this is during a crowd reaction period there are a variety of emotions expressed, which transform over the 10-20 second period. This can be split into phases. The first is typically a highly animated release of tension displayed by the subjects jumping, arms raised and intense facial expressions, lasting between 4-8 seconds. After this phase, subjects often turn to companions to display their emotions to them, embracing them; this second phase reaction is typically between 5-10 seconds after the ‘moment’. Adjusting the positional calibration, per captured ‘moment’, ensures that each image and/or video captured of celebrating individuals will be of a different reaction phase. This will result in images and videos capturing a variety of different reactions, which improves the users experience. The calibration of image and/or video sequence adjustments for each ‘moment’ can adjust per sport and also adjust during the game based on how many suitable ‘moments’ were captured.

During the sequence execution the different components of the module communicate. When the trigger is released the SBC is also triggered and can send an identification number to trigger a specific sequence store, the sequence execution logic. The controller can activate the shutter using an external trigger port, which can be a wired analog connection. The movement commands then begins, moving the multiple-axis robotic mechanism to each position and the controller also moves the multiple-axis robotic mechanism. This sequence can be broken up into the initiation, which recalls the saved sequence movements and ensures the multiple-axis robotic mechanism is at the starting position, the execution, which is the movement and shooting sequence and the finalization, which finishes the movement and moves the multiple-axis robotic mechanisms to the next starting shoot position. The single board computer and driver communicate throughout this sequence process.

FIG. 4B shows a process diagram of another exemplary image and/or video-capture sequence 440 that can be implemented by the imaging modules of the system 100, e.g., as part of the process 200. In this example, module is triggered (442) and a signal is sent to the image and/or video-capturing device to trigger the shutter (444). The image and/or video capturing device trigger can be held down until the shot has been taken (446). The imaging module is notified that the shutter is closed (448), this can be done using the flash sync cable (450) connected to the image and/or video capturing device signaling to the SBC that the flash sync is open and therefore the shutter is closed, therefore the image and/or video has been captured. This signals the release of the image and/or video-capturing device shutter trigger (452). This signals to the motor controller for a movement command (454) to move the image and/or video-capturing device to the next pre-set position (456), the signal of the next set of motor positions is sent (458). For example, the controller can send a signal that the movement is complete or the threshold of movement points are reached. When the motors reach the threshold of the destination (460) an encoder ensures the motor is driven to the correct position (462). Also, once the motor reach the threshold of the destination, there are two methods that can provide feedback that the position is ready for the next shot to be taken. One method of providing movement feedback is the controller sends a signal that the movement is complete or the threshold of movement points are reached (464). A specific timing can be added to this feedback to ensure the imaging device has stabilized (466). In some examples, movement feedback can be provided using an accelerometer to detect the stabilization of the imaging device (468). Once the feedback has been signaled the next shot is taken, the process is repeated (470) from stage (444). Once the last preset position finishes the image and/or video capture sequence, the multi-axis robotic mechanism moves the image capture device to specific position ready to be retriggered (472).

FIG. 4C shows a process flow diagram of an exemplary image and/or video capturing sequence 474. In this example, the imager is triggered (476) which triggers the device's shutter or initiates it to capture an image and/or video (478). After the image and/or video is captured or the shutter is closed, the imaging module is notified (480) and this communicates with the motor controller to move the imaging device to its next pre-determined position (482) and in response the motor completes the movement to the next predetermined position (484). Once the movement is completed, the controller sends a signal to confirm that the movement is complete or the threshold has been reached (486) During this process the motor set positions may be sent for each movement of the sequence (488). A specific timing can be added to the confirmation signal to ensure the imaging device has stabilized (490). Once a feedback has signaled that the next shot is taken, the process is repeated (492) from stage (478). Once the last preset position finishes the image and/or video capture sequence, the multi-axis robotic mechanism moves the image capture device to specific position ready to be retriggered (494).

VI. Positional and Image and/or Video-Capturing Device Calibration

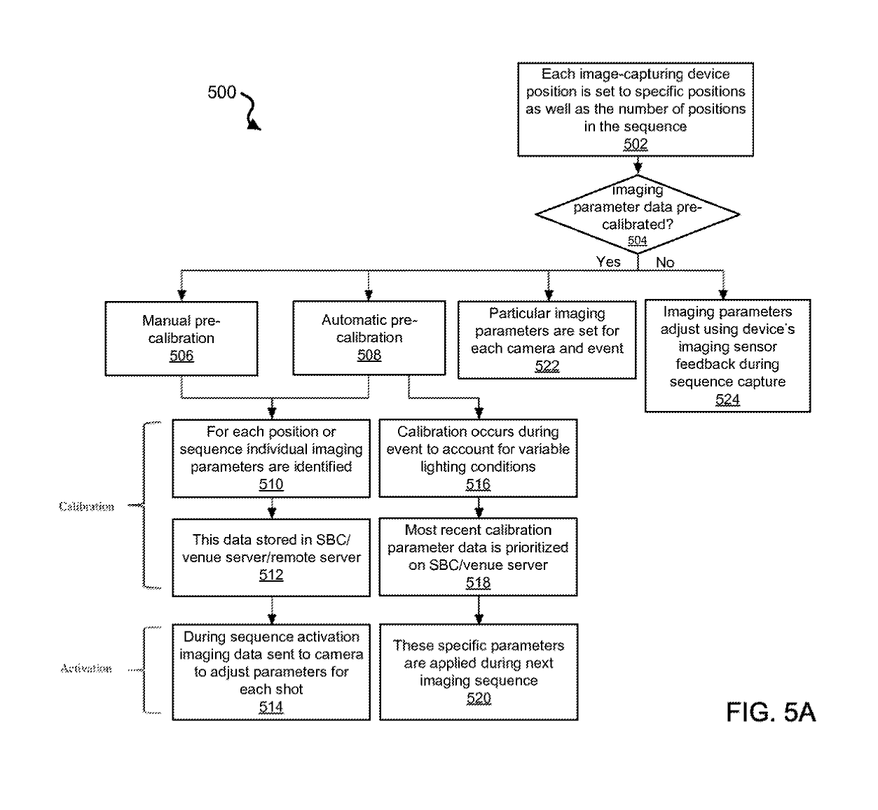

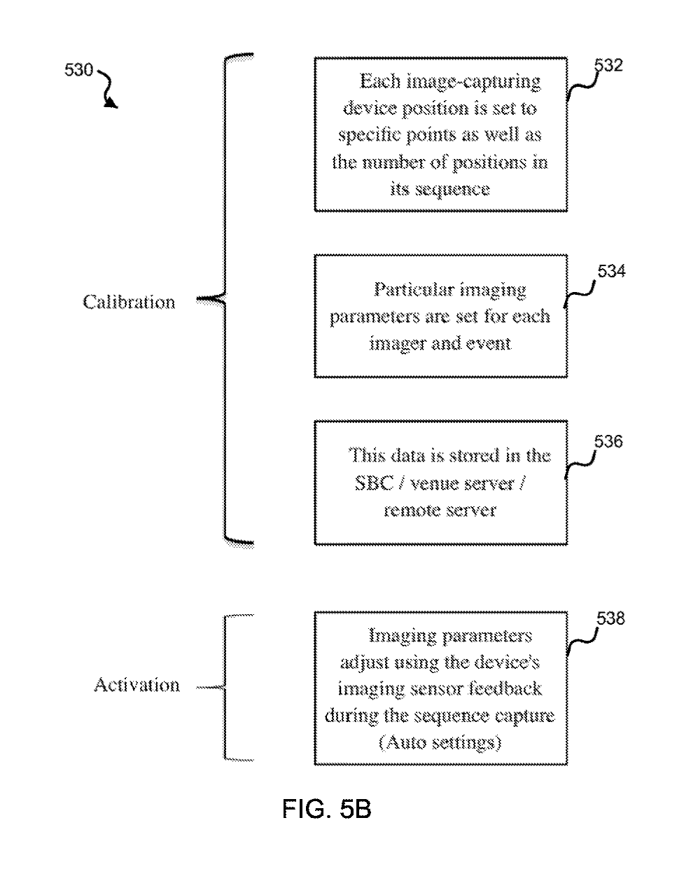

The image and/or video-capturing sequence for each module can be configured to have specific, pre-defined positions for each shot as well as specific image and/or video-capturing device and lens settings. FIG. 5A displays an exemplary imaging-capture sequence 500 for positional and image and/or video-capturing device pre-calibration systems. Each imaging module sequence logic is set to specific image and/or video-capturing device positions (502). The specific image and/or video capturing positions can be stored on each module with the SBC housing this information, and/or the venue server. The number of positions for each sequence and the alternating sequence per ‘moment’ is also stored.

Each imaging module and shot in a sequence may use different imaging parameters given the variability of light at the venue. The image and/or video-capturing device's parameters include any adjustable parameter that alters the image and/or video captured, such as ISO, aperture, exposure, shutter speed, f-stop, depth of field, focus value, zoom on the lens etc.

The device parameter data can be pre-calibrated (504). Device parameters could either be pre-calibrated for each module or even each shot, and the pre-calibration could occur manually (506) or automatically (508). When calibrated manually, each shot position or sequence of shots has the devices' parameters identified (510) and these are stored on the SBC and/or the venue server and the remote server (512). During activation of the module's image and/or video-capture sequence, as the image and/or video-capturing device is being moved to each position, imaging-parameter data (514) is applied for each shot or sequence. This enables each shot to have optimized imaging-parameters, increasing the quality of the image and/or video and reducing the delay of optical feedback when using the image and/or video-capturing devices' sensors. This manual calibration is suitable for indoor venues in which the lighting is set for each event.

For an automatic pre-set calibration (508) the image and/or video-capturing device parameters are automatically identified and stored for each image and/or video or sequence during a variety of times throughout the event (516). This can be just as the event begins, during a break in the event or directly after each time the modules have been triggered. The parameter data, being continually recalibrated, priorities the previous data on the SBC and/or venue server (518) and this is applied during the next imaging sequence (520). This is suitable for outdoor venues in which the light changes during the event, requiring continual recalibration.

In a simpler implementation of pre-setting the image and/or video-capturing device only particular parameters are set for each module and event (522). When the image and/or video-capturing device data is not pre-set, the system uses the image and/or video-capturing devices imaging sensor for particular parameters to be set for each image and/or video (524) and this occurs during the sequence capture.

All data for multiple-axis robotic mechanism positioning and imaging data for each module are saved in the imaging modules, and/or the venue server, and/or the remote server. This ensures that imaging modules can easily be replaced and the specific settings can be uploaded without the requirement of recalibration. Multiple sets of data can be stored for each imaging module so that they can be rapidly applied for different events, light conditions, venue adjustments, etc. To recalibrate the multiple-axis robotic mechanism, the motors can be driven to their maximum pan & tilt position so that the next adjustment value will be a known one eliminating any drift or play in the motors. A remote monitoring and control system can enable these settings to be changed remotely. This can also detect whether any imaging modules are not operating, allowing other imaging modules to capture the additional images and/or videos that would have been missing.

FIG. 5B shows a diagram displaying an exemplary image and/or video positioning and activation sequence 530. In this example, for the calibration of the modules, the imaging position coordinates and the number of positions (532) within the sequence are set and stored within the modules SBC (536). The data can also be stored in the venue and/or remote server for recalibration purposes or even to use when the module is triggered. For each imaging device the imaging parameters can be pre-set and adjusted (534), as well as adjusting for different events at the venue. During the activation of the imaging sequence-imaging parameters such as the focus value etc. can rely on the cameras automatic settings to use the imaging sensors to feedback these values and apply them to the images and videos being captured (538).

VII. Image and/or Video-Capturing Device Robotics Control

Features such as the lens zoom, focus value and shutter activation can be controlled using software. The zoom and focus can be all adjusted to pre-calibrated values as the multiple-axis robotic mechanism moves across its imaging-capture sequence so those values are stabilized before the image and/or video-capturing device has landed at each position, reducing the delay to activate the shutter. These features can also be controlled manually using robotics, acting in the same manner as a software controlled device, driving the focus and zoom values to pre-calibrated positions for each shot in the sequence to reduce delay until each image and/or video is shot. The advantage of this is that manually adjusting these values may be faster, reducing image and/or video capture delay. It can also act as a failsafe if any issues with software occur the manual system can be implemented.

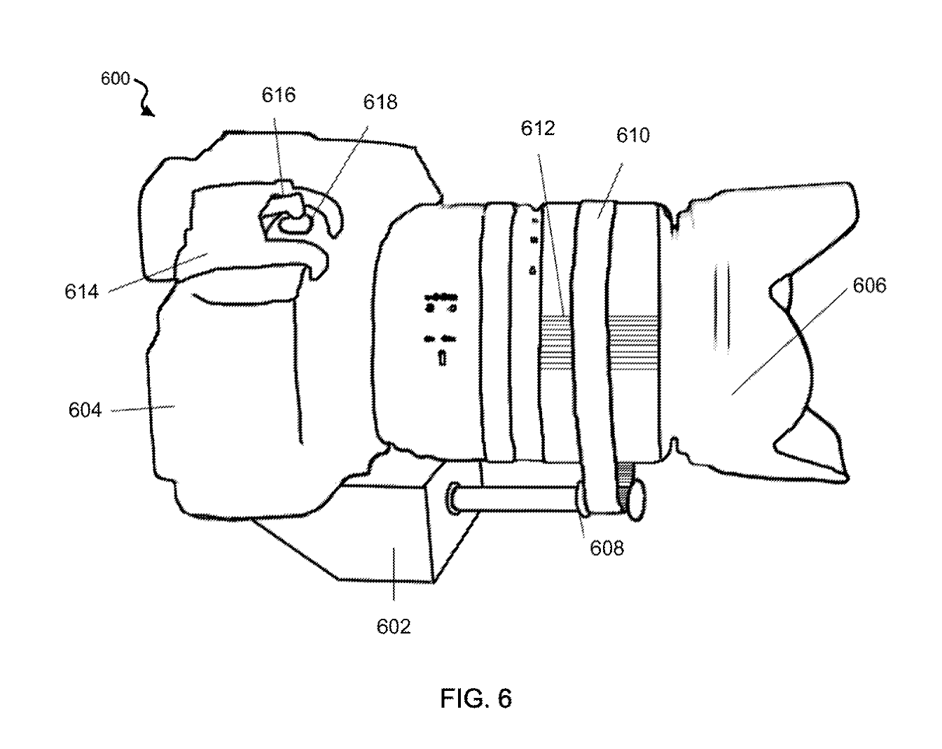

FIG. 6 displays exemplary robotics 600 associated with an image and/or video-capturing device to manually adjust zoom and focus on a lens and depress a shutter. An electric motor 602, attached to the image and/or video-capturing device body 604 or lens 606, rotates the motor shaft which can be connected to a pulley 608, which pulls a belt 610, that is connected to the lens's rotating adjustable focus or zoom ring 612. Multiple motors could be used to control both the zoom and the focus ring on separate belts. For manual depression of the shutter an electric motor 614 is held to the image and/or video-capturing device body, moving piece 616 to depress the shutter button 618. The control of this motor is precise enough so it can be calibrated to depress the shutter only slightly, so the image and/or video-capturing device focuses without taking an image and/or video. The advantage of this is that this semi-depression can be triggered as soon as the multiple-axis robotic mechanism lands the device at a position and automatic focus can begin while the device stabilizes. Once completely stabilized the shutter can be fully depressed to shoot the in-focus image and/or video. Another method of triggering the shutter is by using an analog hardwired connection or using software. The image and/or video-capturing device autofocus can operate instead or with the manual focus-adjusting ring.

To recalibrate the zoom or focus value, the motor can drive the ring or rings to their maximum point so that the next adjustment value will be a known one without drift or play in the lens.

VIII. Image and/or Video Transfer Software

The images and videos can be transferred from the image and/or video-capturing device to a server so they can be accessed by individual attendees. The software can monitor the image and/or video-capturing device for when the images and videos have been taken and stored. When the image and/or video-capturing devices' images and videos are saved to a storage card the SBC software detects these and they are pulled from the card. These images and videos are labeled, processed and transferred to the venue server and then to the remote server. An alternative method can be to tether the images and videos directly from the image and/or video-capturing device to the SBC or even venue server. Another alternative method can be to use the storage card or image and/or video-capturing device to upload the images and videos to a server either from a wired or wireless connection.

Multiple versions of the images and videos can be captured by the image and/or video-capturing devices, e.g., a large RAW and a smaller JPEG file. Any set of images and videos can also be compressed to reduce file size before uploaded to a user access server. The smaller versions of the images and videos can be uploaded to the venue and/or remote servers faster than the larger ones. The compressed or reduced size version of the images can be uploaded first so individuals can obtain their photos quicker from the time they were taken. This is important to ensure images and videos can be delivered while the individual attendee is still witnessing the event, and maintaining the excitement of the moment. The larger sized image and/or video files can be uploaded after the smaller sized files so that these ones can be sent to be printed when requested, but with less time pressure given the delays associated with printing and delivery of physical goods.

When the images and videos are not compressed or retain the same resolution from when shared to being printed or saved, the images and videos can be increased in quality for printing using automated image and/or video manipulation software. A pre-set manipulation is applied for each image and/or video or sets of images and videos, which can be to adjust pixels, repair focus, adjust the contrast, exposure, saturation, etc.

IX. Image and/or Video Operation Software

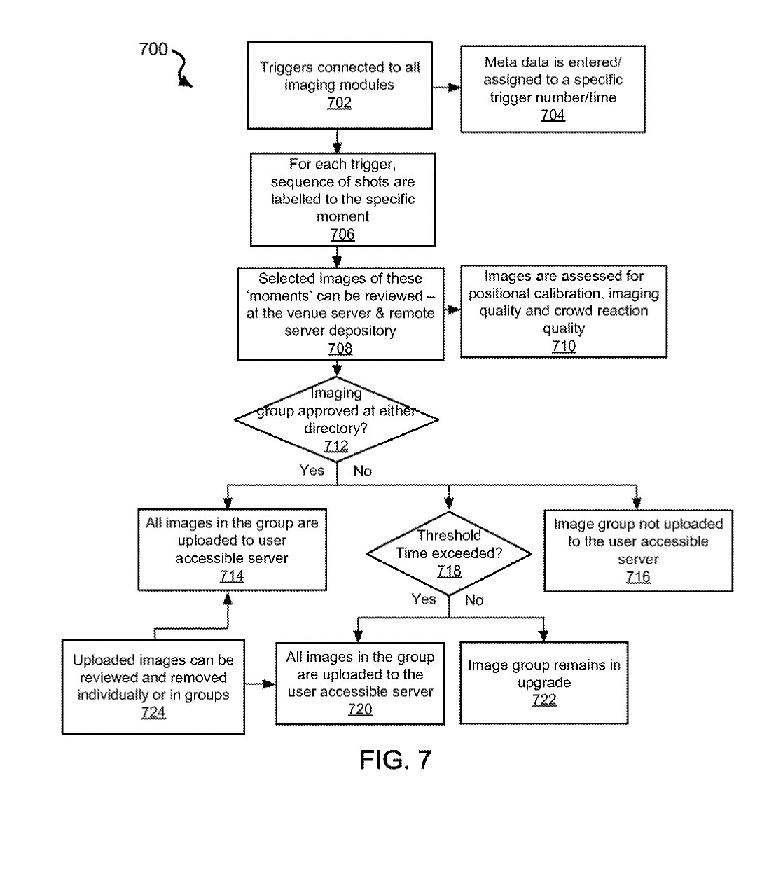

FIG. 7 shows a process flow diagram of an exemplary process 700 performed using image and/or video quality operation software to control which and how many image and/or video moments go to a server for user access.

The imaging modules are triggered (702) and the meta-data (information regarding the ‘moment’) is entered or assigned to the specific trigger number or time (704) or made through a third party API call. The sequence of shots taken for that trigger/‘moment’ produces a series of labeled images and videos, which are grouped to be associated with that specific trigger number or ‘moment’ (706). These groups are sent to a server, either venue based or remotely so that they can be reviewed (708) for positional calibration, image and/or video-capturing device quality and crowd reaction quality (710). The image and/or video group can then be approved at either the venue or remote server (712). However, in some examples, all or a sample image and/or video must be uploaded there first. When approved, all of the images and videos in the group are uploaded to the server accessed by the users (714). When not approved or rejected the image and/or video batch is not uploaded to the user accessible sever (716). The system can also be set so that a time threshold controls the image and/or video uploading to the server. When the time threshold is exceeded 718, the group of images and videos are upload to the server accessed by the users (720). If the threshold is not exceeded then the images and videos may remain in a pending mode and not uploaded to the user accessible server (722). The images and videos that have been uploaded to the user accessible server can also be removed by the whole group or individually (724).

The potential advantage of this system is to ensure image and/or video quality and the amount of images and videos uploaded is controlled. Controlling the quality is desirable due to the difficulty in gauging the crowd reaction quality. Images and videos with little emotion are not as impressive than ones capturing people ‘in-the moment’ and the best method of gauging this is for someone to manually review a sample of the images and videos taken for each group/moment. Controlling the amount of images and videos uploaded is based on data server upload restrictions. In some implementations image and/or video upload policy can be restrict to upload only the highest quality images and videos to prevent a time delay when the user can access their images and videos.

An image and/or video retention policy on the SBC and/or the event server is also implemented. The image and/or video retention policy can be used to manage the limited storage available on the depositories on SBC and the event server. The retention policy can be set to automatically remove the images and videos after they have been transferred to either the event server or remote server. Alternatively a predetermined set number or storage space worth of images and videos can be stored and then when the limit is reached the oldest ones start to delete in a first-in-first-out manner. This can also be applied so that the images and videos are only stored for a set amount of time. The same above methods could also be implemented by saving the images and videos on another storage device.

X. Location Identification Processing

For individual attendee to access their images and videos, the specific area of the specific image and/or video are assigned to respective individual attendee's location e.g., a seat number. The images and videos that are captured are previously indexed with reference points and/or cropping functions that will take into account for dead space (areas without people). The calibration processing is stored and applied to the specific labeled images and videos. This processing could occur at the local (venue) or remote (cloud) server.

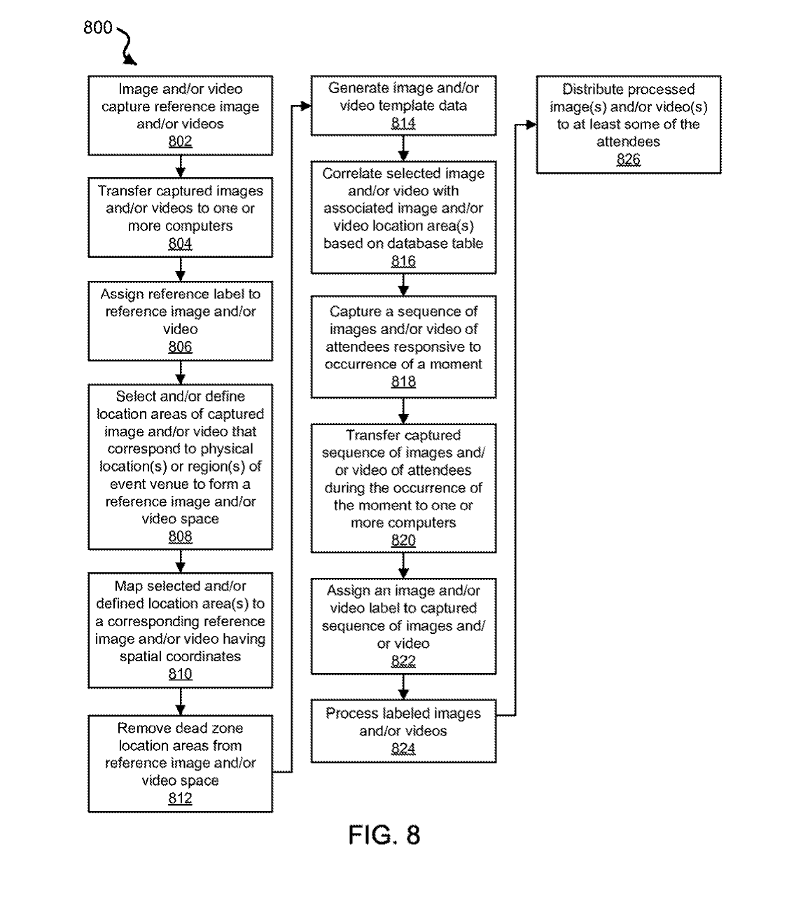

FIG. 8 is a process flow diagram showing an exemplary process 800 to capture and process reference or calibration images and videos at an event venue. The process 800 can include image and/or video-capturing reference images and/or videos (e.g., such as a sequence of images and videos) of one or more sections of the event venue (802), e.g., using image and/or video capture devices installed in the event venue. In some implementations, for example, the process 800 can include transferring the captured images and/or videos to one or more computers (804) (e.g., the venue server and/or a remote server or servers). The process 800 can include assigning a reference label to reference image and/or video (806). When a sequence of reference images and/or videos are captured, a reference label is assigned to each image and/or video in the sequence. For example, the reference label can include a code corresponding to the event venue, the image and/or video capturing device that captured the reference image and/or video, and a sequence number of the reference image and/or video.

The process 800 can include selecting and/or defining image and/or video location areas of the captured reference images and/or videos that correspond to physical location(s) or region(s) of the event venue to form a reference image and/or video space (808). The process 800 can include mapping the selected and/or defined image and/or video location area(s) or region(s) to a corresponding reference image and/or video space having spatial coordinates (810). For example, the spatial coordinates of the reference image and/or video space can be based on pixel map of the reference image and/or video. In some examples, the process 800 can include removing particular image and/or video location areas that correspond to a ‘dead zone’ or regions of non-interest from the reference image and/or video space (812). The process 800 can include generating image and/or video template data for each of the image and/or video location areas associated with each of the reference images and/or videos (814). For example, the image and/or video template data can include image and/or video size data based on at least a portion of the reference image and/or video coordinate space that is substantially centered on the image and/or video location area, e.g., for each selected image and/or video location area. For example, the image and/or video template data can be generated based on calculations that determine an amount of image and/or video space (e.g., pixel movement in the exemplary pixel map of the reference image and/or video) to surround the selected image and/or video location area (e.g., such as a seat in the event venue) for each image and/or video in the sequence. For example, the calculations can be based on parameters including, but not limited to, (1) where the selected image and/or video location area (e.g., the seat in the event venue) will be centered, (2) the zoom and other image and/or video capturing setting data that were applied at the image and/or video-capture of the reference image and/or video, and (3) the angle of the images and/or videos.

For example, the image and/or video template data and other reference image and/or video information are stored onto a server, which can be used to map to images and videos taken during an event of attendees at the event venue to capture their reactions to particular moments or occurrences during the event. In some implementations, for example, the mapped image and/or video location areas in the reference image and/or video space can be mapped to individual seats and/or event venue locations where the attendees can be located during the event. The mapping of such exemplary physical locations to the reference image and/or video space can be used for rapid image and/or video processing of the images and/or videos captured during the moment or occurrence, e.g., which can be provided to the attendee just after the moment or occurrence (e.g., post manipulation images and/or videos). In some examples, the process 800 can include using database tables to allow for correlations between each of the individual images and videos of the selected image and/or video location area (e.g., seat image and/or video) and the associated image and/or video location area (e.g., seat) based on it, place in the image and/or video capture sequence (818).

The process 800 can include, during an event at the event venue, operating any or all of the image and/or video capturing device to capture a sequence of images and/or videos of attendees of the event situated at the physical locations for a duration based on an occurrence of a moment at the event (818). For example, the image and/or video capturing devices that capture the sequence of image and/or video during the occurrence of a moment at the event can be operated in the same or similar manner as performed for the image and/or video capture sequence of reference images and/or videos, e.g., such that the imaging parameters of the images and/or videos captured during the occurrence of the moment correspond to the imaging parameters of the reference images and/or videos (e.g., focus, zoom, angle, etc.). In some implementations, for example, the process 800 can include transferring the captured images and/or videos of attendees during the occurrence of the moment to one or more computers (e.g., the venue server and/or a remote server or servers) (820). The process 800 can include assigning an image and/or video label to the captured sequence of images and/or video (822). For example, an image and/or video label can be assigned to each image and/or video of the sequence of images and/or videos in which the image and/or video label includes at least some of the corresponding information as in the reference label. For example, the image and/or video label can include a code corresponding to the event venue, the event, the image and/or video capturing device, the occurrence, and a sequence number of the image and/or video captured during and/or after the moment or occurrence at the event.

The process 800 can include processing the captured images and videos at the one or more computers that received the captured and labeled images and/or videos (824). For example, each of the images and/or videos of the sequence of images and/or videos can be processed at the one or more computers in communication with the image and/or video capture devices. In some implementations, the processing the captured and labeled images and/or videos can include applying an iterative function to the captured and labeled image and/or video determined by data calculations, e.g., which can use pixel by pixel specifications in the image and/or video template data of the image and/or video location area (corresponding to the physical locations or regions of the event venue), to produce new processed images and/or videos for each of the image and/or video location areas, e.g., in which a new processed image and/or video is centered on a corresponding physical locations or regions of the event venue and including a surrounding region of that location, which may show the attendee and/or neighboring attendees at that location during/after the moment or occurrence, for each of the sequence of images and/or videos. For example, the processing the labeled images and/or videos can include producing the new processed images and/or videos for at least some or all of the image and/or video location areas for at least some or all of the sequence of images and/or videos captured by at least some or all of the image and/or video capture devices. In some implementations, processing the labeled images and/or videos can include copying the ‘raw’ images and/or videos captured during and/or after the moment or occurrence at the event to form a copied image and/or video. In some implementations, the processing the labeled images and/or videos can include obtaining the image and/or video template data of the reference image and/or video that corresponds to the image and/or video to be processed, e.g., based on the image and/or video label information that corresponds to the reference label information. In some implementations, the processing the labeled images and/or videos can include, using the image and/or video template data to form a new processed image and/or video of an image and/or video location area from the raw or copied image and/or video. e.g., for each or at least some of the image and/or video location areas in the image and/or video, in which the new processed image and/or video has image and/or video properties according to image and/or video template data that is associated with the image and/or video location area mapped in the reference image and/or video space. For example, the processing forming the new processed image and % or video can include editing including cropping the raw or copied image and/or video based on the image and/or video size data defined in the image and/or video template data.

The process 800 can include distributing the processed image and/or video to at least some of the attendees (826), e.g., based on location information of the attendees. For example, the location information includes at least one of location data from a mobile device of the attendee or a seating location in the event venue. In some implementations of the process (826), for example, an attendee can provide their location data (e.g., their assigned or current seat number, or mobile device location information (e.g., GPS location)) to the one or more computers, e.g., which store the new processed images and/or videos. In some examples, the attendee can provide the location data during the event soon after an occurrence or moment, for which they wish to request the new processed images and/or videos. In some examples, the attendee can provide the location data (e.g., of their assigned or current seat number during the occurrence) and an event identification at any time after the event. For example, the new processed images and/or videos can be stored on computer systems that can be accessed through a database that links and sorts through the new processed images and/or videos based on information including the location information corresponding to the image and/or video location area and event information, e.g., corresponding to the event venue, the event (e.g., name of event, date of event, etc.), etc. In some implementations of the process (826), for example, the distributing can include providing an array of image and/or video links (e.g., including a thumbnail image and/or video, and/or title/name of the image and/or video, and/or identifying information of the image and/or video, for each image and/or video in the array) to the attendee user, e.g., using a mobile device application or web portal to access selected images and/or videos in the array.

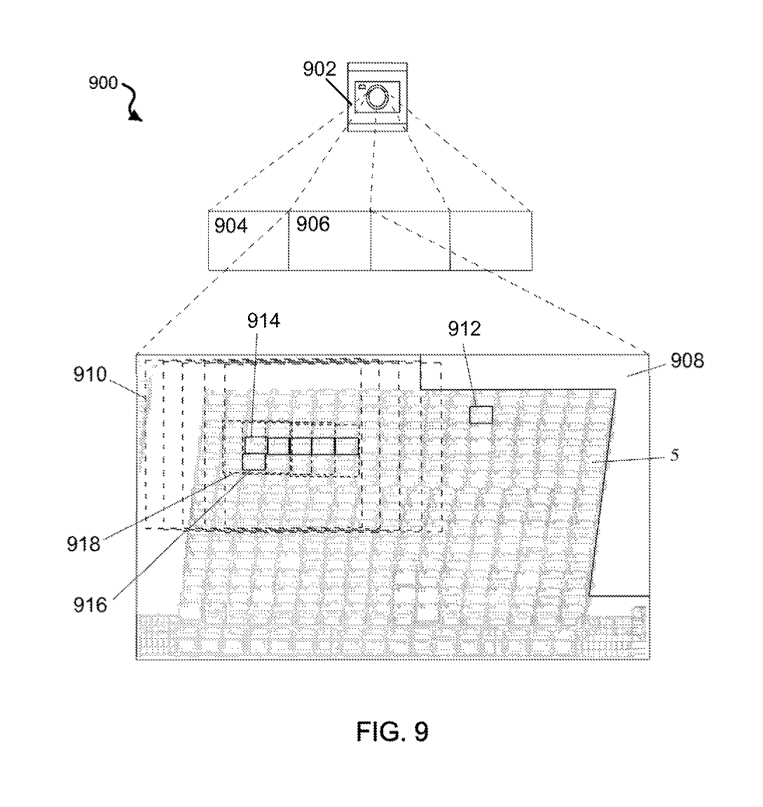

FIG. 9 is a block diagram showing an exemplary image and/or video indexing software data flow associated with location identification processing. Calibration is used for each installation once the image and/or video sequences are set. The image and/or video-capturing module 902 captures a series of images and/or videos 904 and 906. The images and/or videos are labeled with the specific venue, event, module number, moment number and sequence number, e.g., Venue/Event/Module No./Moment No./Sequence No. Each image and/or video, such as 906, is indexed or calibrated to the specific locations of individuals. Either the dead space is removed from being calibrated, area 908, or the specific crowd location areas 910, are selected for calibration. A reference point area represented by a size of individual seats or a specific crowd location area is set, shown by 912. These reference points are then iterated across the calibration area shown by 914 to identify the specific positions of individuals' locations or seats by using a function associated across the image and/or video. Each reference point placed is indexed to specific coordinates such as seats e.g., Section 3, Row 22, Seat 12 will be assigned to reference point 914. For example, when iterating the reference points 914 and 916, the reference points 914 and 916 may be moved horizontally, vertically and also at varied angles, staggering the movements by certain pixel sizes e.g., horizontal iterations of the reference points in image and/or video 906 move vertically by predetermined number (e.g., 10) pixels for each iteration. This is the same adjusting for different angles of the crowd, so the area of the reference point may have to increase or decrease during each iteration, to compensate for the varied distance to the image and/or video-capturing device. The reference points placed act as a focal point for centering the individual spectators and each has its own cropping radius surrounding it. A set cropping size is shown by 910, which surrounds and corresponds with reference point 914. These cropping radii iterate as the reference points iterate. When the newly cropped images and/or videos 910 are processed they are labeled so that all of the corresponding reference points, and therefore locations/seats, are indexed to them. As well as a cropping a relatively large radius 910 around the reference points of the images and/or videos 914, which is displayed when a user selects the image and/or video, a smaller radius 918 is also cropped. This cropping is also associated with each reference point and iterates as the reference points do. This smaller cropped image and/or video is used as a thumbnail image and/or video so that users can scroll through each moment and see their specific reaction before selecting the image and/or video, which will open the larger cropped image and/or video for them to edit/share etc.

The calibration is set so all of the image and/or video reference points, iterations and the associated cropping is stored and assigned/indexed to locations. This processing can then be applied to specific images and/or videos taken during a live event at the venue. During the event the imaging-module captures a series of images and/or videos. All images and/or videos will have a specific processing which will apply the specific reference point iterations and cropping depending on the labeling of each image and/or video. The same processing will be repeated for the same sequence number for each moment and module. During the event, image and/or video 906 is captured and the cropping function is applied at a server in which all reference points are applied to move the crop radius to specific points. Multiple images and/or videos are created from the series of cropping applied and these are associated to the seating position allowing the user to recall their image and/or video. When a user wants to recall their series of images and/or videos, the location information such as seat number corresponds to the labeled ID, which identifies and allows access to the series of images and/or videos or they are sent to that specific user. The advantage of this method is so that all the processing and associations occur before the user recalls them allowing for faster recall times and less stress on the servers.

Identification of correlations between the images and/or videos with certain variables such as the position area size, the angles associated with them and any patterns in dead space or calibration areas can be performed. These variables can be adjusted for each image and/or video and applied across all images and/or videos.

An alternative method of calibrating the cropping area position is to manually pinpoint the center of the cropping area and assigned each to the location/seating data.

An alternative method of processing the images and/or videos when captured is to dynamically crop them when the user requests their series of images and/or videos, in which the requests are queued and the images and/or videos are only cropped when requested.

As many individual images and/or videos are being taken of the venue, the spectators towards the edge of the images and/or videos will either receive a smaller cropped image and/or video or the images and/or videos being captured will overlap to reduce this effect. Depending on the users reference point the cropped image and/or video is taken from the image and/or video with the most distance from the edge of the image and/or video.

For any of the processing methods, data from the user is used to locate their specific images and videos. Instead of seat location data being inputted from the user this could also be a unique code that is associated with the spectators' locations or in conjunction with geolocation data or Bluetooth/other wireless protocols from their mobile device. When a user enters their event and location data this specific ID opens the specific image and/or video or set of images and videos.

XI. Exemplary Venue Set Up

XI.1. Positioning and Angles

The modules can have specific placements within the venue to ensure specific vantage points and optic requirements are abided to. For example, this can dictate the imaging modules arrangement, angles used, the modular design and how the imaging modules are attached to the venue.

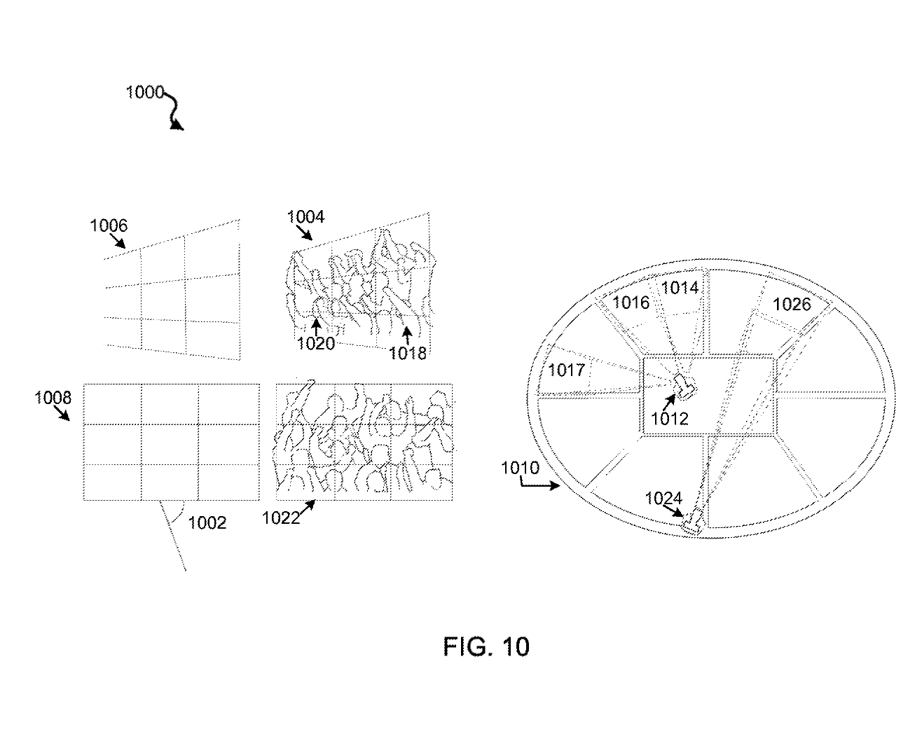

The first angle specification is for the image and/or video-capturing device to face the crowd shown in the diagram 1000 of FIG. 10. During the emotional moments, spectators often raise their arms. If the image and/or video-capturing device captures the crowd from at a perpendicular angle less than 60°, in relation to the plane of the crowd shown by 1002, many of the individuals in the crowd would be blocking their own or other crowd members faces, reducing the subject quality of the image and/or video shown by 1004 when the crowd plane to the image and/or video-capturing device module is as shown in reference 1006. When the crowd plane is above 60°, in relation to the image and/or video-capturing device module, perpendicular to the crowd, shown by reference number 1008, then the subject quality is improved, as the crowds' arms are no longer blocking their faces.

Having specific vantage angles corresponds to the system including imaging modular units, placed in various strategic positions at the venue. In this example, these specific vantage angles indicate that the image and/or video-capturing device modules are placed in specific areas in relation to the crowd. This is exemplified in venue 1010, where an exemplary imaging module 1012 is placed in an area in which, when the multiple-axis robotic mechanism of the imaging module 1012 pans, the angles of images and/or videos taken of crowd sections 1014 and 1016 have an angle above 60° perpendicular to the plane of the crowd. When the imaging module 1012 pans towards crowd section 1017, the image and/or video focal plane is perpendicular with the imaging module to allow all subjects to be in focus. Also, exemplary imaging module 1024 is placed in an area to have the image and/or video focal plane for crowd section 1026 to be perpendicular with the imaging module to allow all subjects to be in focus.

As well as using specific horizontal angles for subject quality it is also used for the optics and imaging quality. This is due to the depth of field differences if the crowd plane is at an angle above 60° perpendicular to the plane of the crowd. This is shown in image and/or video focal plane 1004 where the subjects 1018 are closer to the module than subjects 1020 which will result in a difference in focus between these two areas, making the image and/or video quality poor and out of focus of certain areas. Whereas image and/or video focal plane 1022 is perpendicular with the imaging module, allowing all subjects to be in focus.

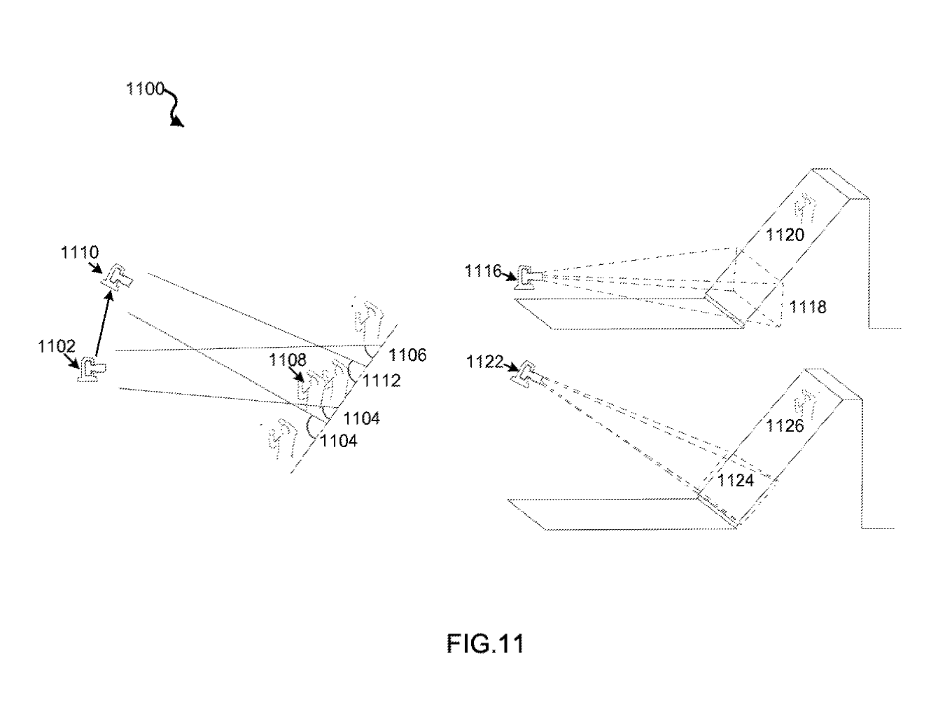

Arm to face obstructions have a big impact on image and/or video subject quality with the horizontal angles of the modules but this also relates to vertical angles as well. The vertical vantage points are important to prevent head to head obstruction, which would occur if the modules were placed too low relative to the subjects. This is shown in a diagram 1100 of FIG. 11, with the imaging device 1102 having an angle below 30°, angles 1104 & 1106 perpendicular to the crowd's stand, which results in the subject 1108 blocking the spectator behind them during a celebration. If the imaging device is raised in height to 1104 and the angle is above 30°, angles 1112 and 1114 perpendicular to the crowd's stand, the subjects 1108 are no longer blocking each other when an image and/or video is captured due to the viewing angle.

The depth of field issue also applies to the vertical angles of the module to the crowd stand. When the imaging module is placed at position 1116 the focal plane of the imaging sensor is at 1118, which does not match the crowd stand plane of 1120 causing focusing issues in areas of the image and/or video captured. When the module is raised to position 1122 the imaging focal plane 1124 matches the crowd stands plane of 1126, resulting in all/most areas of the image and/or video being in focus.

XI.2. Imaging Module Attachment

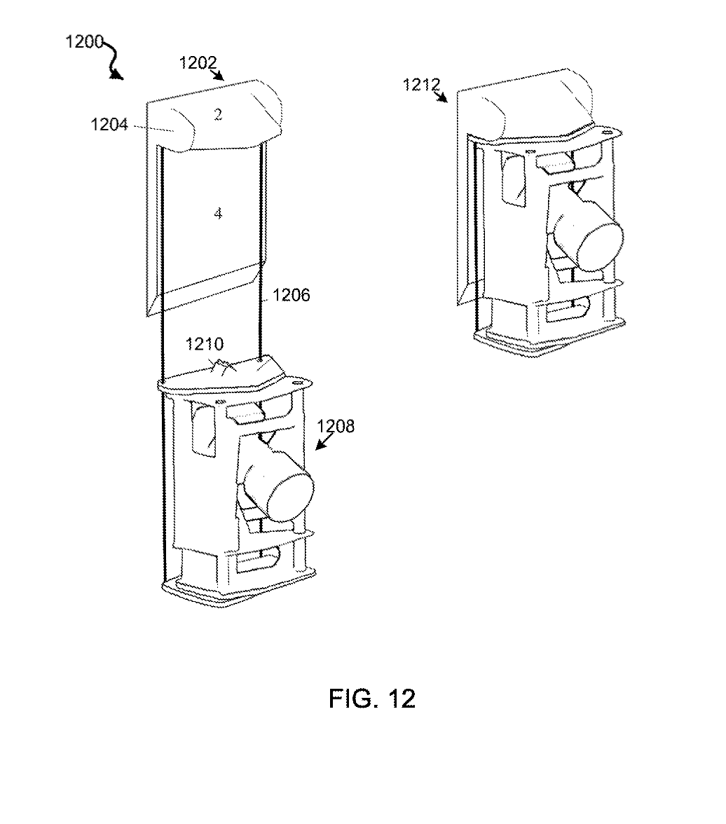

As the imaging modules use specific angles that will often need installations at height, above 20 m from the crowd stands, their attachment positions may be in difficult to access areas. If the imaging modules are installed outdoors they can be removed after each venue to prevent weathering or theft. To access these imaging modules and remove them easily a cable attachment system 1200 can be used, shown in FIG. 12. The bracket 1202, attached to venue infrastructure, uses motors 1204 to lift or lower the cables 1206 attached to the imaging module 1208. Once the imaging module has been raised to fit to the bracket both power and data 1210 connects through to the venue infrastructure. To secure the module to the bracket clips, electromagnets, motor tension etc. can be used. Reference number 1212 shows the module locked into place on the bracket attached to the venue.

XI.3. Wired-Platform

An alternative structure for venue installation of the modules is to use a suspended platform held by wires over the center of the venue. This allows smaller lenses to be used, as the image and/or video-capturing devices will be capturing crowds that are closer in distance, which are cheaper and lighter for rapidly movements. The platform would have to be held from at least 3 cables to give it stability. The inertia from the modules moving to each shoot position could shake the platform and effect image and/or video quality. To counteract this a counter balance could be added to each module, which moves in the opposite direction during movements to cancel out any force that would lead to platform shake. Alternatively the imaging module movements can be timed and set to move at the same time in opposite directions, so they act as the force counterbalance to prevent vibrations.

The imaging modules could also be attached to other infrastructure based in the venues center such as jumbotrons, lighting platforms, etc.

XI.4. Lighting

For high quality image and/or video-capture, having sufficient light on the subject is crucial. In some venues the lighting is below this level, which may require a specific lighting system to accompany the imaging-modules.

One method can be to use the existing venue lighting system and have the lights synced with the trigger system so that they turn up for the duration of the sequence or strobe when the modules are capturing each shot.

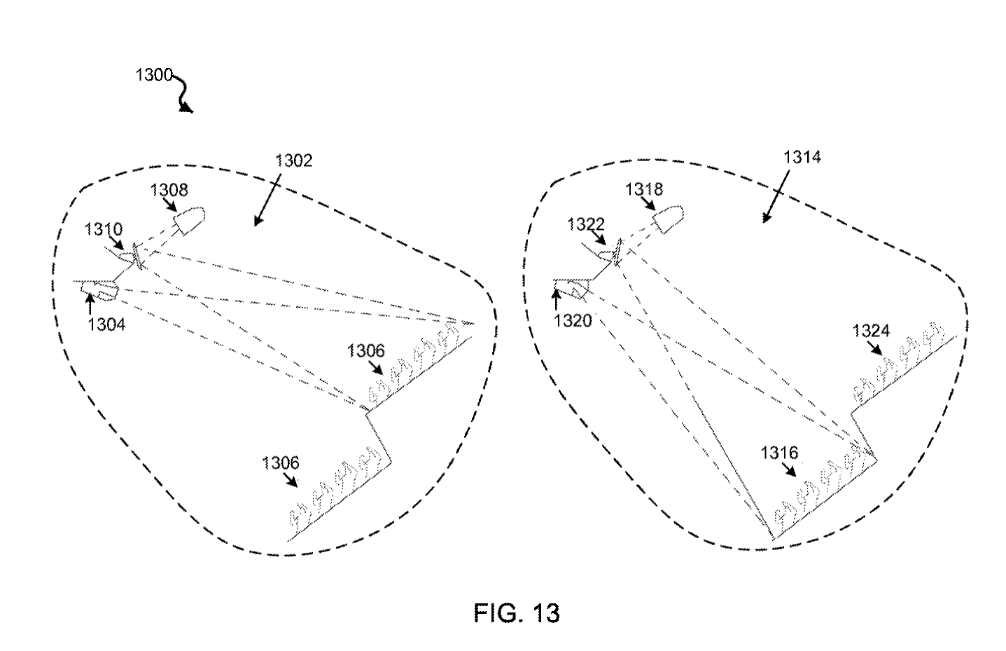

An alternative method is to add a new lighting system, which also pans and tilts as the image and/or video-capturing modules do, calibrated to be focusing the light on the subjects at the specific time of image and/or video capture for each section. Lighting systems are heavy and difficult to rapidly pan and tilt, to get the light beam to focus on the subjects when being shot. To overcome this the lighting system can remain static, facing away from the crowd and focused on a pan and tilt mirror/reflective system that reflects the light beam onto the subjects. FIG. 13 shows an exemplary lighting system 1300. The capture shot of time 1302 shows an imaging module 1304 is pointed at crowd subjects 1306. The light source 1308 is pointed at the mirror/reflective system 1310, which reflects the light onto subjects 1306. The light system 1308 and imaging system 1304 are calibrated and can communicate to ensure the light beam is focused on the subjects when the image and/or video is taken. Subjects 1312 are not being captured during this movement in time so can remain in darker conditions. The next shot time 1314, shows that the imaging module is now shooting subjects 1316 and the mirror/reflective system has adjusted in angle to reflect the light beam onto subjects 1316. The lighting system 1318 remains stationary, only imaging module 1320 and mirror/reflective system 1322 pan and tilt, with now subjects 12 in darker conditions.

The benefit of this lighting system 1300 is so that the amount of lighting systems are reduced as less photons are required because they are beamed on a specific area for only a small period of time, changing angle every 0.5-1 second. The benefit of the mirror/reflective system 1310, 1320 is that it is very light in weight and can be moved with less powerful motors and simpler robotics.

XII. Monetization Choke Points

The platform in which the images and videos are delivered and used upon has specific features, which allow for commercialization opportunities.

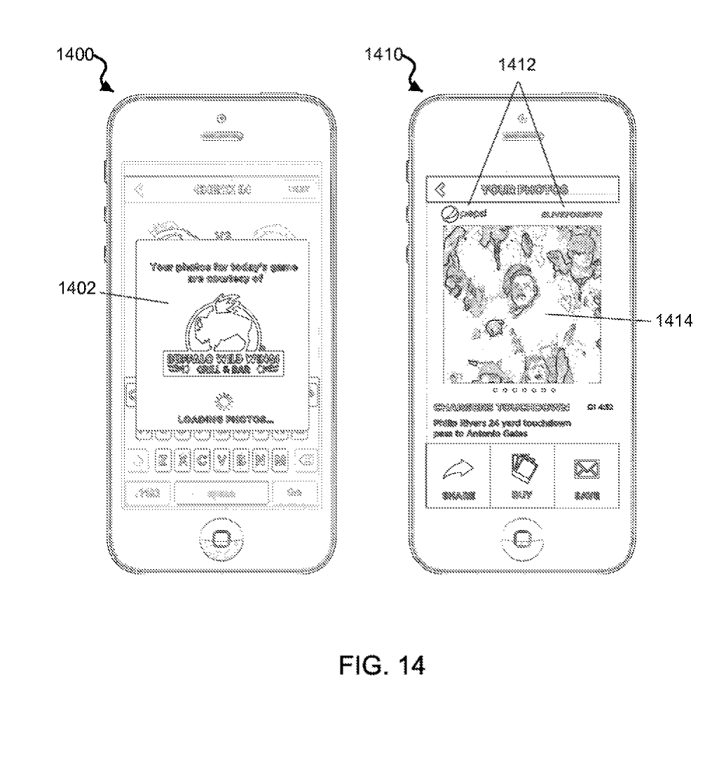

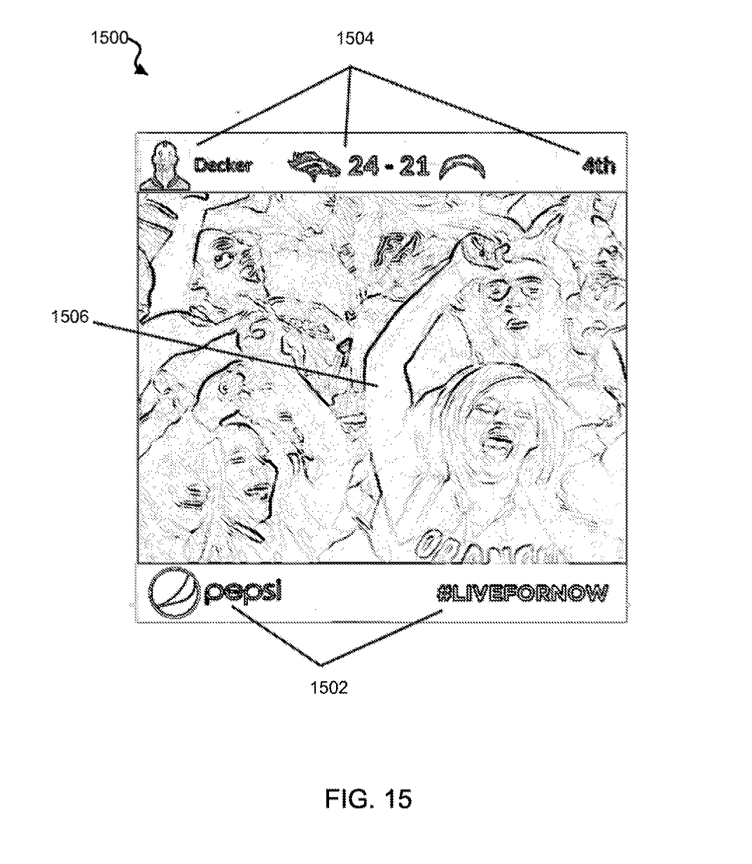

One method of implementing commercialization is for brands to associate themselves with the reaction images and videos captured. FIG. 14 include diagrams 1400 and 1410 showing exemplary service (including customized content) delivered to attendee users. When a user is delivered or accesses their images and/or videos from an event, a pre-constructed delivery or loading screen can display an image and/or video, video or other advertising based information shown by 1402. When the images and/or videos are ready to be viewed by the user, further advertisements can be displayed in the areas surrounding the images and/or videos, shown by 1412. As each image and/or video is scrolled through 1414, the advertisement displayed can also adjust to deliver a more dynamic and detailed message to the user.

Within the web/application, the user can choose the image and/or video they desire to crop and adjust/edit. During or after this period, specific meta-data about the event and moment can be added to the image and/or video. For example, in a sports event, this can be images and videos of the players involved in the play, team logos, scores etc. When the image and/or video is pushed to an external social network or emailed, this meta-data is added to the actual image and/or video. This can be shown in FIG. 13, in which an image and/or video has been constructed with the associated meta-data 1414.

As well as the event meta-data being added to each image and/or video, so can images and/or videos and text from brands. This is so that when users share their images and videos the brands can be associated with the viral sharing associated with emotional and personalized images and/or videos. This is also highlighted in a diagram 1500 of FIG. 13, in which the associated advertisements 1502 and added contents 1504 are constructed on the images and/or videos 1506.

All methods of associated image and/or video sponsorships can be specifically allocated to users based on user profile data such as their sex, age, location, usage rates. etc. to identify the most suitable branded message for each set of image and/or video recalls/access. This associated branding can also adjust depending on the events meta-data with prebuilt images and/or videos and rapid text changing during the event. For example if the event was a high scoring soccer game the advertisement could adjust rapidly adjust the branded to suit this game, discussing the high amount of goals etc.

A higher quality digital version of each image and/or video can be purchased in which an uncompressed version of the image and/or video is to the user. A physical print of the image and/or video can also be purchased in which the image and/or video and associated event data is sent to a printing facility.

XIII. Expiring, Concealed Promotion System

To entice the application or mobile web users to purchase items, an expiring, concealed promotion system can be implemented. The aim is to provide the user with excitement during a normal mundane purchase scenario by giving them a randomly generated promotion or piece of information that could provide a benefit to their purchase, but will expire after a certain time period. This will drive users to go to a specific location to purchase goods. The draw for the user is that they do not know what the promotion will be until they are ready or even after they have purchased a good. This provides the element of surprise, even gambling and brings excitement into purchases.

In some aspects, a method for providing a hidden promotion to mobile device users includes identifying a location of an individual using at least one of location data from a mobile device of the individual or a check-in site where the individual has gone; sending a notification to the mobile device of the individual including a concealed promotion offer associated with a future purchase from a selected vendor at a vendor location based on the identified location, wherein the concealed promotion is sent to the individual inactive; and revealing the concealed promotion to the individual when the individual activates the concealed promotion proximate the vendor location, wherein the concealed promotion is configured to have a limited time period of availability after being activated.

In some implementations of the method, for example, the individual can include an attendees at an event venue to spectate an event. In some implementations of the method, for example, the attendee includes a plurality of individual attendees at the event venue. In some implementations, for example, the method can further include, prior to the revealing the concealed promotion, receiving a verification by the vendor indicating that the attendee is proximate the vendor location. In some implementations of the method, for example, the concealed promotion can be configured to be revealed only one time. In some implementations of the method, for example, the concealed promotion can include at least one of an image and/or video, text, or video. In some implementations of the method, for example, the concealed promotion includes one or more of a price discount on the future purchase, a free product or service available with the future purchase, or a charitable donation by the vendor with the future purchase.

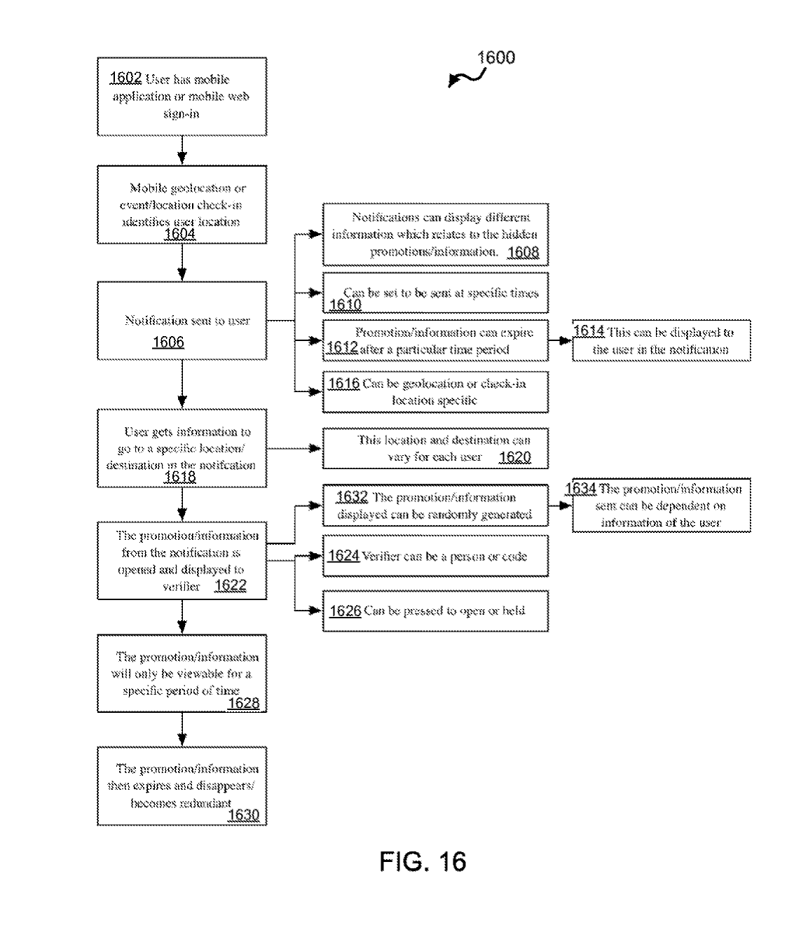

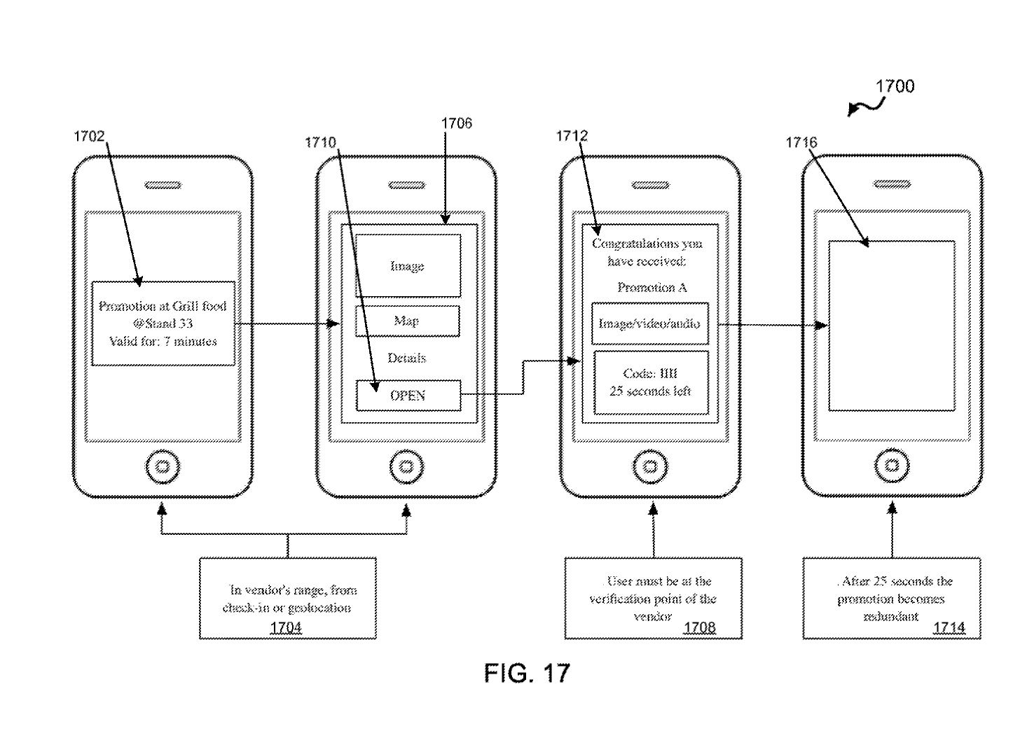

An exemplary system and process 1600 for providing an expiring and concealed promotion is shown in FIG. 16. An attendee user accesses a mobile application profile or a mobile sign-in profile (1602), which is used to identify which promotion information and associated notification is sent to that individual. Mobile geolocation or an event/location check-in identifies the users location (1604), which is used to identify which promotion information and associated notification is sent to that individual. A notification about the hidden promotion is sent to the user device (1606). The notification can display different information relating to the hidden promotions/information (1608). Each notification can display information to the user, which can relate to the content of the hidden promotion, this could be a different level of notification such as gold, silver or bronze, which relates to the content benefit on the hidden promotion. This notification information could also be information about the product or venue offering the promotion.

The notifications can be set to be sent to users at specific times 1610, to a group of multiple users at the same time or sporadically spaced out to individual or groups of users over a set time period. This ensures users receive promotions at relevant times for their usage. The notification and associated promotion can also expire after a particular time period 1612, and this expiration time can be displayed in the notification 1614, and when going to the promotion to see additional information, but without triggering the opening of it. The notification sent to the users and its associated information and promotion offered can be geolocation and/or check-in location specific 1616. This ensures users receive relevant promotions based on proximity.

When the user receives the promotion notification, information about the specific destination or location where the user must open it is displayed, either on the notification or associated with it 1618, but without triggering its opening. This location/destination can vary for each user including time period, notification and promotion 1620.

The user then must go to the location/destination to open the promotion to display its information to a verifier 1622. This verifier can be a person that is acting as a vendor for the good, or a code that must be quickly entered or scanned into the vendors system 1624. To activate the promotion for display it can either be pressed or held to show the information 1626. This promotion is only viewable for a specific period of time 1628, before it expires and disappears/becomes redundant and can no longer be displayed and/or used 1630. The promotion can only be opened once.

The promotion opening can be triggered just before the purchase occurs, during, after an order for goods has been complete but before payment or after, when the goods have been paid for to receive a refund. This refund could go back to the user in cash, on a payment card, or given back in credits for use at another vendor visit.

The promotion and its associated notification and information can be randomly generated 1632, to provide the excitement to the user as the economic benefit of the promotion varies. The promotion sent can also be dependent on, or alter the random generating promotion algorithm, based on user information 1634, such as their specific profile level. The promotion being displayed when opened can either be an image and/or video, text, a video or a combination of these. The location of user is also identified when opening the promotion to adjust the information if they are in the vicinity of the promotion collection vendor or not. A promotion can include money off a specific good, free goods etc. for individuals as well as multiple people through one profile. Instead of a promotion, which offers an economic benefit to the users, the promotion can be replaced with other information such as images and videos, texts or videos which have an expiring time period and again can only be opened and viewed once for a set period of time.

### Example 1

A generic example of this system could be for any vendor, including outside of a stadium or event venue, such as a street restaurant. The restaurant sets a series of promotions of what to offer and the quantity of each promotion offered, such as 200×10% off food, 50×2 free drinks, 30×free starters, 5×free 5 free dishes. The restaurant also sets the time the promotions are sent, such as 5:30 pm, the time the promotions will be valid for, such as: the next 30 minutes, and the amount of time they can be viewed once opened, such as 30 seconds. The restaurant sets up each promotion, which can be an image and/or video, video and text, which explains the specifics of the notification and the promotion when opened.

When a user of the application or mobile web user with a profile is located within a 3-mile geolocation range of the restaurant, which is variable, at the time the vendor wants the promotion to be sent at, e.g., 5:30 pm, a random promotion notification is pushed to the user. The set of promotions, which the random one is taken from, can vary depending on the users profile level, such as making it more likely to get a better promotion for a loyal customer. The notification will state the restaurant's name, location and other information such as the menu and reviews etc. It will also state the promotion is only valid for the next 40 minutes and makes it clear not to open it until the user is at the vendor during the purchasing process. The notification could also indicate if it's different from normal promotions pushed such as a gold level one due to customer loyalty or a unique promotion and indicates what the promotion could be.

The users location can also be regularly tracked to push unique notifications and promotions to users that are not regularly in that area, to entice new customers.

The users of the app can also connect to their friends, family and colleagues via their phone numbers or social network connections. This allows the notifications and promotions to be sent to multiple people when they are within a certain range of each other. This can be to be people that are in the physical company of each other, showing the same geolocation data, and either the same promotion or varied promotions can be sent to each person but all at the same time.

A promotion can be sent to just one person in a group, known from geolocation and group connections, with information about the promotion being for multiple people and even the specific people in close proximity that could benefit from the promotion.

It can also be for users who have connections within a range, but not in the physical company of each other. This allows users to contact each other and agree to go to the venue or location to activate their promotion. The user can then go to the restaurant, within the promotion period, and place an order, showing the verifier the offer by opening the promotion. The verifier can be restaurant staff, by inputting a code, scanning a code or an alternative mode of verifying the information displayed on the promotion. This information can only be displayed for a specific period of time for verification, such as 30 seconds. The user could then have received the two free drinks promotion, in which they receive this with their purchase. Once the 30 seconds expires, and the promotion has not been verified, the promotion becomes redundant and/or disappears.

This vendor could also be any venue or service, selling a variety of goods such as meals, drinks, groceries, clothing, hotels, electronic items, transportation, entertainment products etc.

### Example 2

A crowd venue specific example of this system could be a soccer stadium during a soccer game. The venue sets a series of promotions of what to offer and the quantity of each promotion offered, such as money off tickets or merchandise, half price drinks/food or cheaper physical copies of their reaction images and videos. The venue also sets the time the promotions are sent, such as 10 minutes into the first quarter, the time the promotions will be valid for, such as: the next 8 minutes, and the amount of time they can be viewed once opened, such as 30 seconds. Each promotion, which can be an image and/or video, video and text, explains the specifics of the notification and the promotion when opened.

When a user of the application or mobile web user with a profile is located within the venues geolocation range, or if a user check-ins at the event or venue, a random promotion notification can be pushed to the user at a specific time. The set of promotions, which the random one is taken from, can vary depending on the users profile level, such as making it more likely to get a better promotion for being a loyal customer for the team by going to multiple games each season. The notification will state the promotion type such as drinks, the collection location such as concession stand 12. It will also state the promotion is only valid for the next 8 minutes and makes it clear not to open it until the user is at the vendor during the purchasing process. The notification could also indicate if it's different from normal promotions pushed such as a gold level one due to customer loyalty or a unique promotion and indicates what the promotion could be.

The users location can also be regularly tracked to push unique notifications and promotions to users that are not regularly going to the concession stands, to entice new customers. The users of the app can also connect to their friends, family and colleagues via their phone numbers or social network connections. This allows the notifications and promotions to be sent to multiple people when they are at the stadium together. A promotion can be sent to just one person in a group, known from geolocation and group connections, with information about the promotion being for multiple people and even the specific people at the stadium that could benefit from the promotion.

The user can then go to the concession stand, within the promotion period, and place an order, showing the verifier the offer by opening the promotion. The verifier can be the staff, by inputting a code, scanning a code or an alternative mode of verifying the information displayed on the promotion. This information can only be displayed for a specific period of time for verification, such as 30 seconds. The user could then have received the 20% off food promotion, in which they receive this with their purchase. Once the 30 seconds expires, and the promotion has not been verified, the promotion becomes redundant and/or disappears.

A benefit of this is to encourage stadium-based sales but also to assist with preventing queues at concessions by encouraging users to purchase goods at certain times and at certain locations. The promotions can also adjust, with their message depending on what is happening in the game e.g., the home team scores a hatrick so more promotions for 3 free beers become offered with an associated message.

FIG. 12 displays the user experience of the expiring, concealed promotion system. The users mobile device is sent a notification 1702, which can provide information on the vendor and location and how long the promotion is valid for. This notification is sent if the device is in a specific geolocation range or the user has checked-in to a specific place within this range 1704. When the notification is opened 1706, further information can be provide such as images and videos, maps, timer on how long the promotion is valid for, further promotion information, reviews etc. and an open button. If the user chooses to go to the vendor to use the promotion they must go to the verification point 1708, and press the open button 1710, to display the promotion 1712. This will reveal the concealed promotion and can include further details, images and videos, video, audio or code that can be viewed, entered or scanned by a verifier or verifying system. Also displayed on this screen is the time left until the promotion expires. Once the promotion time has expired 1714, the promotion becomes redundant and can no longer be used 1716.

XIV. Exemplary Video Capture, Processing and Delivery System

A photograph or video of the spectator(s) attending a live event, e.g., a sports event, a concert, etc., can provide a unique and yet highly beneficial and desired memento or keepsake for a spectator, especially if the image or video can be captured at a precise moment, tailored to remind the spectator of that specific moment, and easily and rapidly obtained. However, to achieve this, there are many technical difficulties. For example, some main issues or difficulties include capturing the image or images and/or video or videos in a short period of time and at just the right moment, capturing the image or images in focus of the individual spectator and/or group of spectators in the context of the moment, preparing the captured image or images and/or video or videos so they can be easily and rapidly accessed, e.g., such as directly to the user and/or integrating the image content into a social network, e.g., particularly a social network with a series of specific mechanisms with a unique interface.

An online social network is an online service, platform, or site that focuses on social networks and relations between individuals, groups, organizations, etc., that forms a social structure determined by their interactions, e.g., which can include shared interests, activities, backgrounds, or real-life connections. A social network service can include a representation of each user (e.g., as a user profile), social links, and a variety of additional services. For example, user profiles can include photos, lists of interests, contact information, and other personal information. Online social network services are web-based and provide means for users to interact over the Internet, e.g., such as private or public messaging, e-mail, instant messaging, etc. Social networking sites allow users to share photos, ideas, activities, events, and interests within their individual networks.

Techniques, systems, and devices are disclosed for implementing an image- and video-capturing, processing, and delivery system to obtain the reaction images of attendees at large events, e.g., including sports games, concerts, etc., and provide this content to form personalized videos and/or images of the attendees.

Spectators often desire to leave events with something to remember and share with friends and family, such as a memento from their experience. The disclosed technology includes advancements in imaging technologies, and platforms to share content, which coincide with complementary advancements in personal communication devices and Internet connectivity. The disclosed technology includes designs and methodologies to supply high-quality, personalized content, including images and video, to attendees. For example, the image and video content can include specific images, video, and audio of the attendees and the event with pre-defined processing to rapidly supply a product to the attendees/users. For example, users of the disclosed technology can then edit the images or video content for further personalization to save or share on social platforms.

To capture personalized image or video content of attendees at large event venues requires specialized hardware and software technology. For example, this is to capture the attendees emotional reaction during very specific and small time periods when exciting moments occur during the event. Also, for example, this is also to ensure each user obtains their specific images/video, crucial to the personalization and processing of the content captured. This exemplary content captured and processed by the disclosed technology can also be integrated into existing digital media coverage to enhance the viewer/readers experience by providing a feeling of familiarity and personalization.

Exemplary Trigger System

Similar to image capturing, a trigger system can be used to capture videos. During emotional moments at events the reaction period duration differs for each type of moment. Therefore the trigger system can be held for the duration of the attendees reaction to capture content for the desired period. When the motions of cameras are facilitated by robotics capture selected sections of the venue at a time, throughout the reaction period, then a short reaction period may not be sufficient time to capture the entire crowd at the venue. This could result in different moments being captured and supplied to different users in various sections at the venue. For longer reaction periods the trigger can be engaged for more time to capture all users at the venue.

Series of Images/GIFS

Both still images and video content can be captured and delivered individually to a user or as a processed series of pieces. An image-capturing device can be a digital camera, which is set to take a series of burst images of attendees. This set of images can be processed to merge or transition between the series to provide the illusion of movement to the piece of content. These images can also be processed to form a GIF (graphics intermediate format) in order to produce a similar effect and also reduce the file size of the piece.

Exemplary Static & Robotic Cameras

A few specific methods can be used to capture the attendees' image and/or video during an event. One is the use of a series of static image and/or video capturing devices fixed on the crowd for continuous capture during the event. Another method is a robotics-controlled image and/or video-capturing device, which continuously moves across a series of pre-defined positions to capture specific sections of the crowd during different periods of time during the event. Ensuring a video can be captured of every fan at one point during the event.

Using robotics-controlled movements of cameras can produce video and/or image content of the crowd during the event but to isolate specific reaction moments of the attendees a trigger or time-based mechanism are used to identify these specific periods. Pre-defined processing segregates the content to associate the content to each specific individual attendee. As well as capturing the attendees' reaction moment, the moment just before the attendees' emotional release is also captured, as the moment just before the attendee's emotional release can display the build of suspense and can provide juxtaposition against the high-energy reaction, enhancing the visual effect.

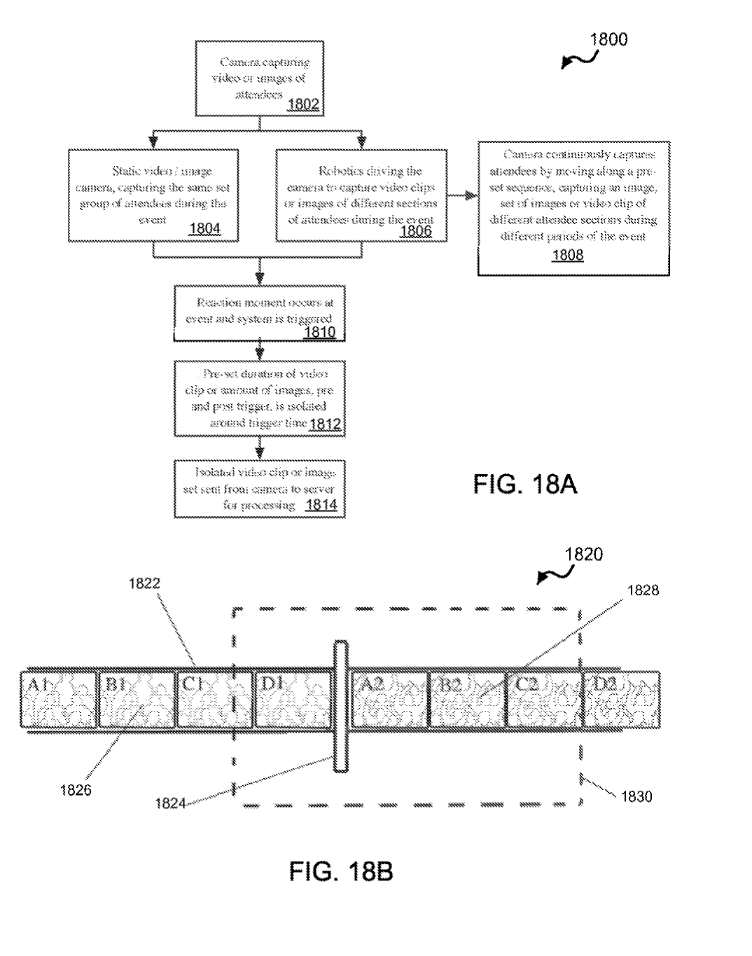

FIG. 18A is a process flow diagram showing an exemplary process 1800 for capturing videos and/or images of one or more attendees at an event venue during an event. The process 1800 includes using image and/or video capturing devices selectively installed around the event venue to capture video(s) and/or images of attendees at the event venue (1802). The process 1800 can include using static image and/or video capturing devices assigned to capture the same set group of attendees during the event (1804). The process 1800 can include using robotics to drive moveable image and/or video capturing devices to capture video clips and/or images of different sections of attendees during the event (1806). The process 1800 can include using the image and/or video capturing devices (moveable by robotic control) to continuously capture images and/or video(s) of attendees by moving along a preset sequence, capturing an image, set of image or video clip(s) of different attendee sections during different period of the event. The process 1800 includes responsive to a reaction moment detected during the event, triggering the image and/or video capture system. The process 1800 can include using a pre-set durations for capturing the video clip(s) and/or images pre and post trigger. The pre-set durations of capturing video clip(s) and/or images are isolated around the trigger time (1812). The process 1800 includes sending isolated video clip(s) and/or image(s) from the image and/or video capturing devices to a serve (e.g., venue server) for processing (1814).

FIG. 18A highlights capture of emotional content with both static and robotic controlled image and/or video capture systems. As described above, in the diagram, 1804 represents operations of the static image and/or video capture system (e.g., static camera system) and 1806 & 1808 represent the operations of robotics controlled image and/or video capture system (e.g., robotics controlled camera system), which moves across pre-defined positions. For either image and/or video capture systems, a trigger system described at 1810 can be activated during a ‘reaction moment’.

The schematic 1820 of FIG. 18B represents an exemplary images or video reel 1822, over a period of time, highlighting a reaction moment segregated by a trigger point 1824. The images or video clips 1826 represents a section of crowd just before a reaction moment, which convoys their emotional response of suspense while viewing the event. The images or video clips 1828 represents a section of crowd during a reaction moment. Both pieces of emotional content are isolated for further processing.

For a static image and/or video capturing-device described at (1804), the trigger point 1824 is identified and a pre-defined duration of video reel, set of images or image is isolated (1812 and 1814) before and after the trigger point 1824, represented by the area 1830. This area/section of video or images contains both the suspense and emotional release of that section of crowd which the device is focused on. This content is then labeled for processing and is eventually sent to the user.

The robotics controlled image or video capturing device described at (1806 & 1808), continuously capture images or video during short periods, capturing various sections of the crowd instead of continuously focusing on the same section of crowd. Therefore the isolation of the video clips or images, pre and post trigger (1824), will mean each clip/image are labeled to ensure they match when combined for processing. For example the image or video clip B1 is labeled and is associated with the labeled B2 as they both represent the same crowd section. This isolates both the buildup and release of emotions for each section of that triggered moment, which are then sent to a server for further processing.

An additional crowd capture method is to use a series of robotics-controlled image/video-capturing devices, which continuously captures only some sections of the pre-defined crowd. When triggered for a ‘reaction moment’ all devices move to a different section of the crowd to continually capture the next sequence for the next reaction moment. This cycle continues through pre-defined positions so that each section of the crowd is captured for some ‘reaction periods’ but not others.

This can also be configured with the trigger system, so that depending on which trigger is activated; the robotics focus the image/video-capturing devices to capture specific pre-defined areas, e.g., for a sports event when the home team scores the devices capture the home support areas.

If the devices are set to continuously capture images or video of the crowd, to prevent the unnecessary data transfer to servers and processing, the content is deleted after a set time duration in which a trigger has not been activated, indicating no desire to identify and isolate the content that has no association with a reaction moment.

Seat Calibration

Users are requested to identify their location within the event using location references entered by the attendee/user: scanning a ticket or utilizing location identification services from their mobile device such as GPS, WiFi or Bluetooth.

The same pre-defined referencing methods described above also applies for capturing reference videos. Each frame or series of frames can be cropped and iterated across the video captured for each individual's location.

As well as a user using a mobile device to identify their location, this can also be done when purchasing the ticket for the event, either entering manually or automatically through the ticket data.

Audio Processing

The audio at the venue is captured throughout the event. This is captured with the video capturing device or separate audio recorders. The timing is also captured so that separate audio and video times can sync. The captured video will also record the time of the capture for each clip. The audio can then be added to the video with matched timings.

Soundtracks can be added to each video and these can be set or based on the meta-data from the event and its associated excitement points. The soundtrack can shift to match marked crescendos of the soundtrack to the exciting moments of the video. The user can also choose or upload a soundtrack added to the video.

Commentator audio can be added to each video using a series of pre-recorded phrases assigned to meta-data and inserted depending on the data applied for the event or actions within the event. These inserts of commentator audio can also be randomly generated for variability between videos.

Variety of Image/Video Content

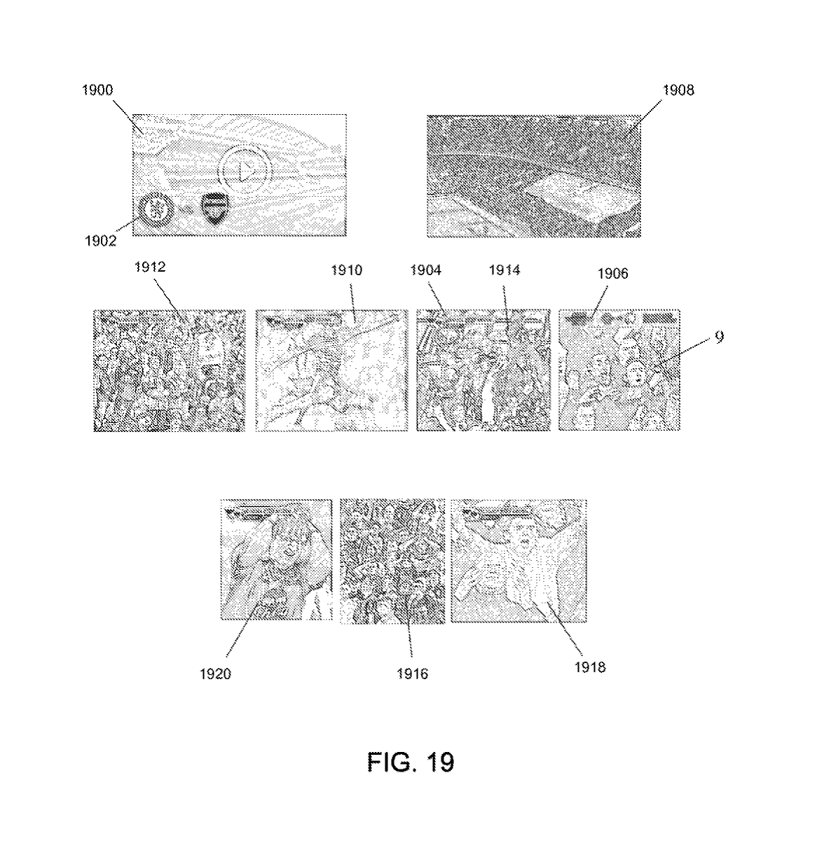

FIG. 19 displays a variety of content that forms a personalized event attendee video using the specific camera mechanisms and processing. The content can include generic scenes that have been videoed before an event (1900), overlaying specific meta-data (1902, 1904 and 1906) on the images/videos, which can be dynamically generated based on events occurring at the event. Additional pre-set robotic or static cameras can be timed or triggered to capture images or videos at the event (1908 & 1910), which can be either of the spectacle or crowd.

One exemplary method of producing content can be obtained by cameras continuously videoing specific sections of the crowd to capture a generic crowd's feelings of suspense build up (1912) and their subsequent reaction (1914) using the same trigger system and video reel isolation as displayed in FIGS. 18A and 18B. This video clip can then be processed with individual images or videos captured from different camera devices, e.g., a transition from the generic crowd reaction video (1916) to the personalized image of the attendees' reaction (1918).

Another method of producing content is to utilize the robotic controlled devices to capture video/images of the crowd during their pre (1912) and post moment reaction (1914) and transition these clips or images using additional footage or images of the spectacle (1910 & 1920).

Each user can be sent a variety of content from the event, this includes their reaction images pre and post moment, a series of processed video clips of each moment, a processed video and image combination, ready to be saved/uploaded, and the breakdown of the video and image combination to be edited by the attendee/user.

Video Editing

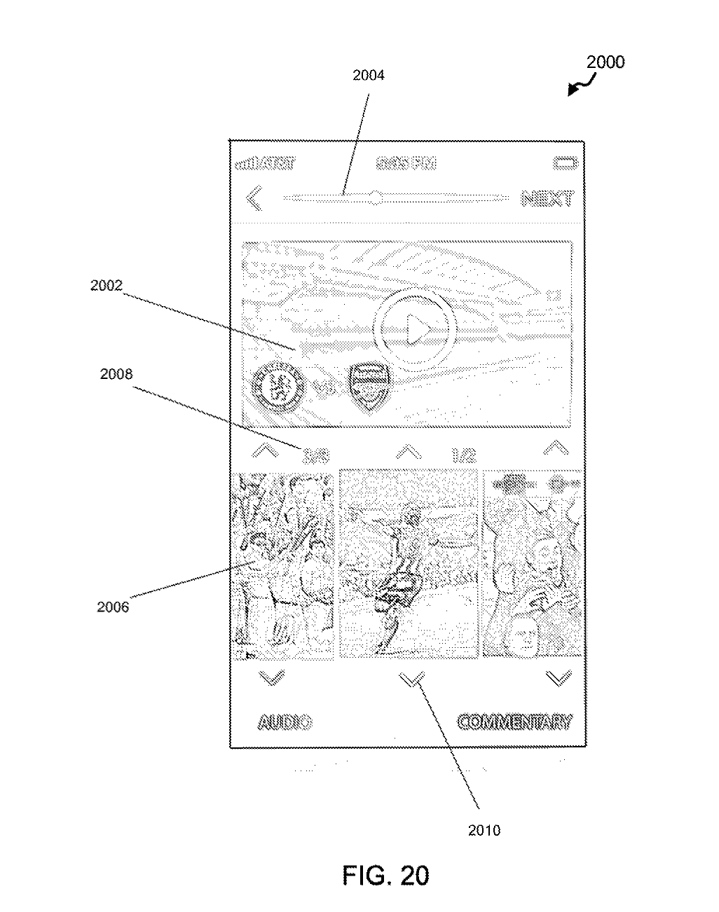

FIG. 20 displays an exemplary video-editing interface 2000 for an attendee/user after they have been sent their video for editing. Area 2002 displays the video to review while editing and area 2004 is the video duration indicator. Area 2006 represents a variety of images or videos (2008) that the user can choose from (2010) to populate their video. The user can also add their own images or videos captured from their mobile devices to the sequence.

Certain images or video clips cannot be removed as these may represent contain sponsorship with the content. When the processed or video breakdown is sent to the user their specific images or videos are integrated and additional footage or images added can be randomly generated so that each user has a unique video combination or can be targeted to supply the most appropriate image/video based on information provided by the user, such as targeted to their age/sex or previous editing preferences.

Hanging Modules

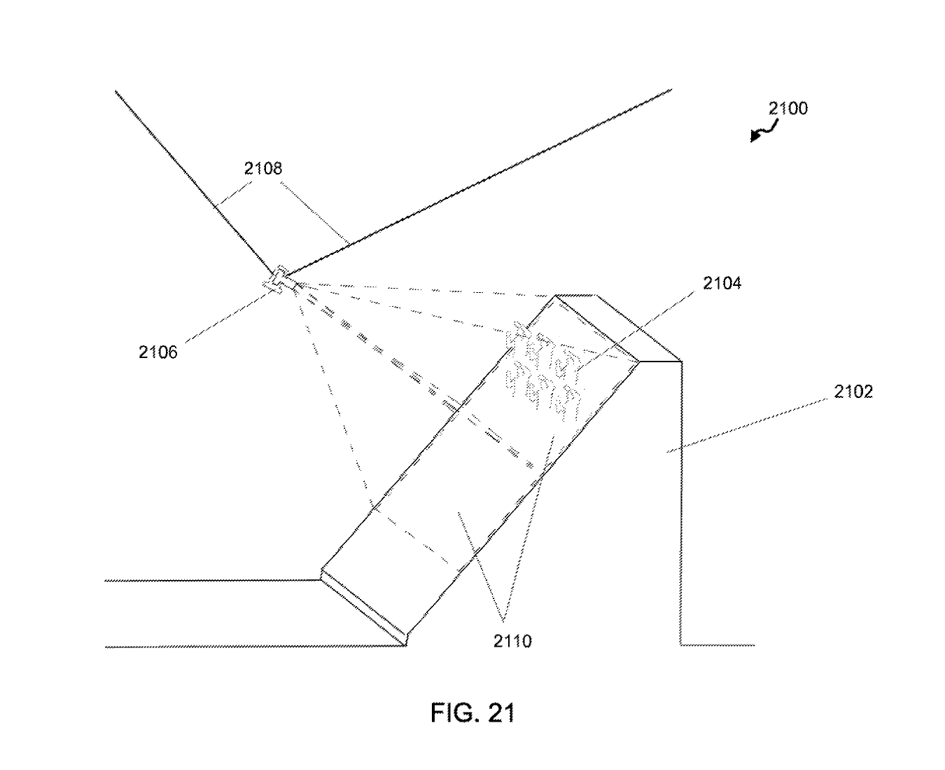

The camera modules can be placed in a variety of positions but require a limit on the perpendicular angle to the crowd which prevents depth of field issues, especially when at a closer distance from the imaging device to the crowd. The imaging/video devices can be placed on the opposite side of the venue to capture the crowd, which requires devices with large lenses/zoom ability. Another exemplary method 2100 shown in FIG. 21 displays the video or image-capturing device attached to a hanging structure perpendicular to the attendees of the event. This requires little lenses/zoom ability. The crowds stand 2102 with its attendees 2104 are captured by the device 2106 hanging from wires 2108. These devices capture either continuous images or videos from a static position or take a snapshot or clip of different sections 2110, using pre-calibrated robotics to move between positions.

As well as having cameras capturing the crowd stands, cameras can also capture spectators in other areas of the venue such as their entry, when they scan their ticket or mobile device.

Integration with Social Media

Events are more exciting to viewers when they know a friend or family member is attending, as it brings them closer to the action via mutual enjoyment of the moment. The content produced from the camera system is a new type of events based media, creating a large quantity of images and videos from event venues, which are likely to be televised, streamed or reported.

Future integration of social platforms with smart televisions and digital media, creates the potential to integrate the emotional attendee content, captured from the system above. The specific emotional images/videos of friends/family during key moments at the event can be placed within current digital pieces distributed, such as live viewing, highlight clips or reports. This produces a personalized experience for each viewer or reader, enhancing the viewer's experience outside the venue as well as inside. For example, when User A has checked into a game using their mobile device or ticket purchase, they are photographed or videoed by the system during an exciting moment at the venue when they are triggered or identified. User A has a connection to individuals B, C and D through social platforms, which are also integrated into media platforms distributing content based around the event, such as video, imagery, blogs, articles etc. This allows the individuals B, C and D to watch live video/highlights or view published media of the event, while viewing the integrated emotional content of their friends/family that has been captured during specific moments of the event.

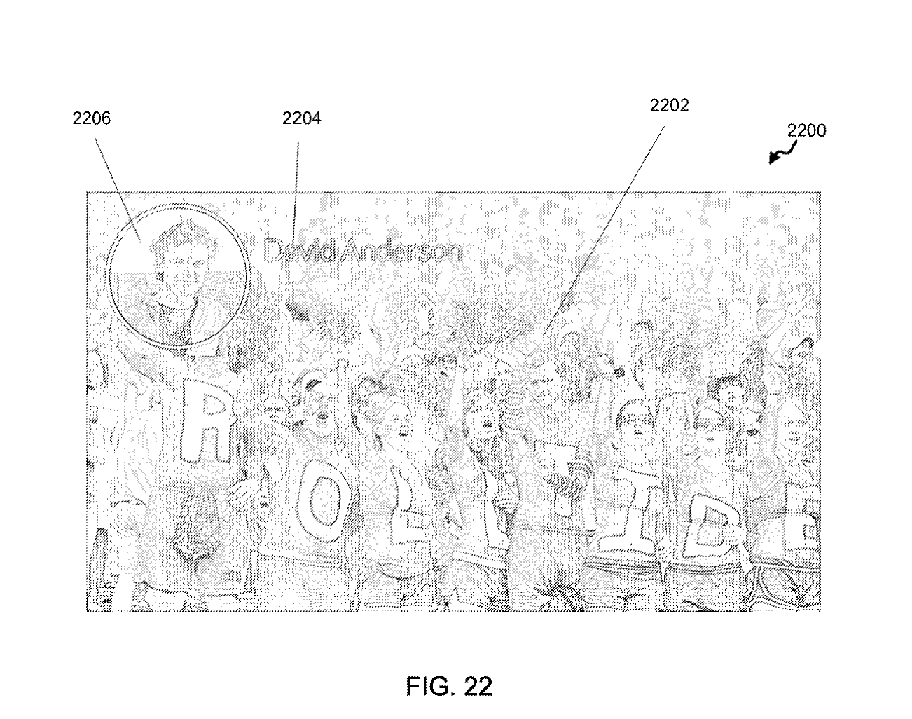

FIG. 22 shows a diagram of an exemplary integration 2200 of the systems captured-content with existing event media coverage and distribution. For example, the image and/or video (2202) displayed during an emotional moment at the venue is shown associated with the clip of the action or in a report. The attendees name (2204) and social platform profile image (2206) is overlaid on the content so the viewer/reader can easily see which of their connections is being displayed.

XV. Exemplary Image and/or Video Capture Technology

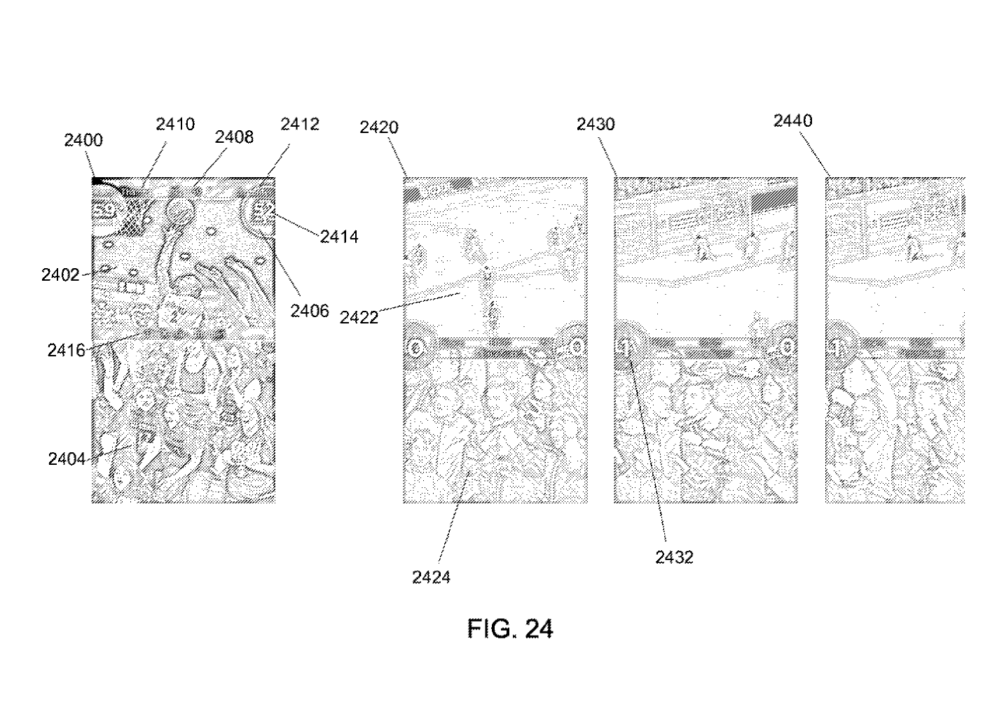

Video/Gif creation using image and/or video infrastructure is described with respect to FIGS. 24 and 25 below using various examples for illustrative purposes.

Automatic Video/Gif Capture

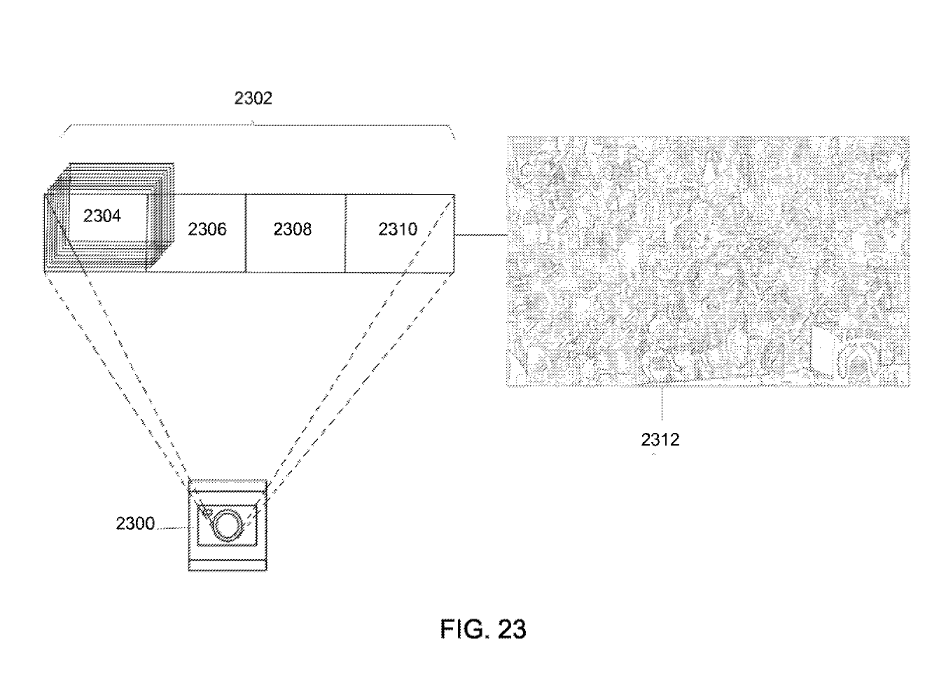

FIG. 23 is a diagram showing and exemplary process of using an imaging module to capture videos and/or gifs of a crowd (e.g., attendee) section as well as images of all the crowd (e.g., attendees) for each triggered event or moment. For example, image capture module (2300) is triggered by a triggering moment or event to capture assigned sequence of images (2302) of each pre-determined crowd sequence (2304, 2306, 2308 and 2310). The video and/or gif is operator or automatically prompted to capture a sequence of images for the same crowd section (2304) so that these images can be processed to form a video or gif. After a short period of image capture (roughly 0.3-4 seconds) at position (2304) the camera module (2300) continues its assigned sequence of shots of 1 image per crowd section for sequence (2306, 2308 and 2310). Reference number 2312 shows an example shot of sequence (2306, 2308 and 2310).

When the image capture system is triggered to capture a trigger event moment, at one or multiple sequence steps, for each camera or multiple cameras, either at random or at a defined sequence step or sequence pattern, instead of the camera or cameras capturing one image for that sequence step they rapidly (over 3 images per second) capture multiple images of the same crowd position. After this capture of successive images at one sequence step the camera or cameras continue its defined capture sequence of the rest of the sequence steps to capture the rest of the crowd during that trigger event.

The above described process of using an imaging module to capture videos and/or gifs of a crowd (e.g., attendee) section as well as images of all the crowd (e.g., attendees) for each triggered event or moment can be used to capture multiple images of a section or sections of the crowd in very close time succession for that trigger event. These indexed images can then be merged or associated to form a gif or video to be recalled by users via their personal devices. This allows users to now view images and videos/gifs of their reaction to triggered events at an event.

The above described sequence of obtaining video/gif capture data is saved to identify which sections of crowd have a video/gif captured of them so that the video/gif is captured of a different sequence step or crowd area for the next event trigger, ensuring the entire crowd will receive a video or gif of at least one of the event triggers during the event, as their will usually be more trigger events than camera sequence steps.

As these images are in high resolution the user can choose which of the frames in the video/gif to isolate and use as an image instead of a processed video or gif.

Operator Prompted Video/Gif Capture

The event system operator can define the trigger event type in which video/gif capture can occur by using a different command to trigger an event capture. For example, the operator sees a potential trigger event about to occur, such as a free kick about to be taken or can predict that a trigger event may occur, the operator can trigger a video capture command in which the camera or cameras capture a series of images from one of their sequence steps and when releasing this command or moving to another command the camera or cameras continue across their sequence steps to capture the rest of the crowd. For example, this could be a free-kick about to be taken by a player, the operator triggers the video/gif capture command and this captured the crowd in anticipation until the free kick is scored, at which point the crowd react, and the operator switches the command to sequence capture of the rest of the crowd. This will enable some of the crowd to receive a video/gif of their suspense and reaction to that trigger event, as well as the rest of the crowd to receive at least an image of their reaction from the cameras continuing their sequence capture along its defined path.

The above described sequence of obtaining video/gif capture data is saved to identify which sections of crowd have a video/gif captured of them so when the operator is ready to capture the next video/gif, the camera or cameras move to a sequence step that have not yet been captured by this video/gif command. This cycles to ensure each user receives can have the best chance at receiving a video/gif capture for the event duration from the multiple trigger events.

Operator System/Operator Commands

The operator can have different commands so that the cameras focus on specific sequence steps to capture images/videos on specific crowd areas dependent on the trigger event. For example, when a specific section is performing an action or reacting to a trigger event differently to other crowd sections. i.e. supporter sections chanting or away fans cheering to an away goal.

To trigger a capture event, the operator can hold a command for a sufficient duration of time which is required to capture the crowd's reaction, the cameras shoot across their defined sequence for this period. When releasing the capture command the cameras stop at a point in their sequence and when triggered for the next capture event they start at where they finished. This enables a user to potentially receive multiple images or videos/gifs for each event trigger, as long as the reaction is long enough to sustain this.

This cycling of image capture sequence steps allows each of the crowd sections to receive the a variety of times in which their captured, i.e. for the first trigger event crowd section A is captured 0.3 seconds after the trigger event and for the second trigger event crowd section A is captured 2.8 seconds after the trigger event. Crowd section F would be captured in 0.3 seconds for trigger event 2, allowing each section to receive a varied reaction type.

Operator Interface

Operator has an interface to define which events are uploaded to be recalled by users, and if capturing video the operator can choose the section of video capture is required to be processed, i.e. the operator can reduce or clip the video if they triggered the capture to early or too long.

Image Software & Photo-Processing

After a trigger event has been captured, all labelled images are processed, such as image cropping, for their specific indexed rule associated. This enables all images to be immediately available when a user recalls their images or videos from the event.

User-Facing Platform

FIG. 24 shows exemplary piece of content 2400 that can be automatically created for users from the captured content and data from the event venue capture system and back-end processing. A piece of content 2400 that can be automatically created for users can be a combination of the event content (curated content) that people are reacting to 2402 (e.g., images and/or videos of a player scoring a goal), the attendees reaction images and/or video(s) (e.g., a cropped image from a user or users, with the users centered) 2404 captured by the systems' cameras, and the meta-data giving contextual information to that event trigger, such as teams playing (or players of the teams) 2406, time of the triggering moment or event 2408, the player causing the triggering moment or event 2410, description of triggering event or moment 2412, the score of the event at the moment or final score 2414, and additional content such as the users' description of the trigger moment 2416.

As well as producing images of this type of content, videos and gifs can also be produced shown in (2420, 2430 and 2440) which shows a series of images from the video or gif that displays a trigger moment. Both video or gifs of the curated content attendees are reacting to (2422) can be shown associated with images, videos of gifs of an attendee or user reacting to it (2424).

The video or gif content 2420 is a combination of event content (curated content) that shows soccer players in action 2422 and reaction images and/or videos of attendees 2424 watching the soccer players during the game. The video or gif content 2430 includes meta-data giving contextual information to an event trigger. For example, the meta-data for content 2430 includes the score of a soccer match 2432 being watched by the attendees. The automatically generated pieces of content 2420, 2430 and 2440 illustrate a sequence of a moment during the soccer game where one of the players scores a goal. The changing reactions of the attendees reacting to the player scoring the goal can be seen in 2420, 2430 and 2440 in sequence. In addition, the score of the soccer game is updated in content 2430 in response to a trigger of the player scoring the goal.

Meta-data can be entered into a console by the operator and this can be associated in to pre-defined groups of data sectioned by venue, teams, players involved, moment type etc.

The above described content can be automatically generated for users so they can edit and share their event story, comprised of key trigger moments, showing consumers of this story the event occurrences, event data and their friends or connections reaction to each event.

In addition to the above described event content data, additional data such as engagement, shares, connections between users is also associated to each piece or groups of content and can be displayed to users who don't have to be in attendance of the event in the most appropriate way. For example, a user can now consume the event story by viewing pieces of content that show their connection or friend, celebrating a trigger event by a specific team they follow, as well as content of the trigger event people are reacting too, all in the same flow, providing a personalized consumption experience, generated automatically and available to consume instantly.

XVI. Exemplary Features

The subject matter described in this patent document can be implemented in specific ways that provide one or more of the following features.

Exemplary Method

In some aspects, a method for providing an image and/or video or images and videos of one or more attendees at an event is disclosed. For example, the method can include operating one or more image and/or video capturing devices located in an event venue that are triggered immediately after a particular moment or period occurs (e.g., a moment or moments of excitement or specific periods during an event) to capture one or more images and videos of the attendees situated at locations at the event venue for a duration after the triggering, e.g., in which the images and videos are of a high image and/or video quality capable of depicting the attendees' emotional reactions during the particular moment or period. The method can include processing the captured images and videos, e.g., in real-time, in which the processing can include determining location identification of the attendees, e.g., by using predetermined positions associated with the event venue, and forming a processed image and/or video based on the image and/or video space. The method can include distributing the processed image and/or video to individual attendees.

For example, the event venue can include, but is not limited to, a stadium, an arena, a ballpark, an auditorium, a music hall, an amphitheater, a building to host the event, or an outdoor area to host the event. For example, the attendees can include fans or spectators at a sporting event. For example, the attendees can include fans or spectators at a musical event. In some examples, the image and/or video capture period of the spectators' reactions can include a duration of 0-20 seconds capture period. For example, the method can include providing the attendees the with the ability to share image and/or video/images and videos to social networks, the ability to save image and/or video/images and videos, the ability to purchase a digital copy, the ability to order a physical print of the images and videos, and/or the ability to purchase the images and videos from a kiosk. In some implementations, for example, the image and/or video capture devices can include one or more digital SLR or digital cameras or an imaging sensor and lens. For example, the distributing step of the method can include wirelessly transmitting the processed image and/or video to a mobile device of the individual. In some implementations of the method, the method can include producing a graphical user interface on a mobile device, e.g., of an attendee, to present the processed image and/or video to the individual attendee. For example, the graphical interface further presents at least one image and/or video of an occurrence of the event, the occurrence temporally corresponding to the processed image and/or video. For example, the graphical interface can include processes for reporting a security-related incident to authorities at the event venue. In some examples, the predetermined positions associated with the event venue can include labeled seating at the event venue.

Exemplary System

In some aspects, an imaging service system of the disclosed technology can include a plurality of cameras arranged in an event venue to capture images and videos of attendees at an event, and one or more computers in communication with the cameras to receive the captured images and videos and provide coordinates to the captured images and videos that correspond to locations in the event venue to associate individuals among the attendees to respective locations in the event venue.

For example, the event venue can include, but is not limited to, a stadium, an arena, a ballpark, an auditorium, a music hall, an amphitheater, a building to host the event, or an outdoor area to host the event. For example, the attendees can include fans or spectators at a sporting event. For example, the attendees can include fans or spectators at a musical event. For example, the locations can correspond to labeled seating at the event venue. In some implementations of the system, for example, the plurality of cameras are arranged in the event venue to capture the images and videos of the attendees at multiple directions. For example, the plurality of cameras can be configured to temporally capture a series of images and videos of the attendees, e.g., in which the captured images and videos correspond to an occurrence of the event. In some implementations of the system, for example, the one or more computers can form a processed image and/or video of an individual or individuals proximate the location of the individual using the coordinates. For example, the one or more computers can distribute the processed image and/or video to the individual using wireless communication to a mobile device of the individual. For example, the one or more computers can send the processed image and/or video to a social network site. For example, the one or more computers can allow purchase of the processed image and/or video by the individual. For example, the one or more computers be implemented to report a security-related incident by an attendee to authorities at the event venue, e.g., based on the images and videos captured and recorded by the system.

Exemplary Trigger

In some implementations of the exemplary method, for example, the operating the one or more image and/or video capturing devices can include manually triggering one or more image and/or video capturing devices to record the images and videos at an operator-selected instance based on an occurrence of the event. In some implementations, for example, the operating the one or more image and/or video capturing devices can include automatically triggering the one or more image and/or video capturing devices to record the images and videos based on sound or mechanical perturbation generated at the event venue. In some implementations, for example, the operating the one or more image and/or video capturing devices can include temporally capturing a series of images and videos of the attendees after one of a manual triggering or an automatic triggering of the one or more image and/or video capturing devices.

For example, the trigger can be implemented to sends signal to all modules, e.g., via radio signal, hardwired communications, wireless communications, and/or use multiple triggers. For example, in some implementations, the imaging modules are hardwired to trigger system. For example, the trigger can include movement monitoring sensors, e.g., which can be triggered by sound or decibel level, and be set with another system that provides electrical signal. In some implementations, for example, the a signal to the operator can be generated indicating that the triggered sequence is complete, ready for a re-trigger. For example, the time of the implementation of the trigger system (e.g., time of trigger) can be recorded for meta-data assignment.

Exemplary Multiple-Axis Robotic Mechanism

For example, the disclosed systems and methods can include an exemplary multiple-axis robotic mechanism. The exemplary multiple axis robotic mechanism can be operated to include servo control, pan & tilt movements (e.g., 180° panning and 60° tilting range), and the capability to rapidly accelerate and stop through a sequence of image and/or video captures. The exemplary multiple axis robotic mechanism can be operated to accommodate a range of image and/or video capture devices, e.g., ensuring center of gravity is retained at intersection of the mechanisms multiple axis. The exemplary multiple axis robotic mechanism can be operated to rapidly move the position of the image and/or video-capturing device's to focus on a different section of the crowd. In some implementations, for example, exemplary multiple axis robotic mechanism can include revolution precision below 0.5° and is able to move 10° in less than 0.25 seconds and stabilize in 0.1 seconds, on both axes simultaneously. For example, the servomotors of the exemplary multiple axis robotic mechanism can provide power to push back to ensure it rapidly stops and stabilize it at a specific rotation point. For example, the exemplary multiple axis robotic mechanism can include optical encoders built into the motors ensure these specific points are driven to correctly. For example, the exemplary multiple axis robotic mechanism can include an adjustable connection point to accommodate a variety imaging-devices and lens size and weights.

In some implementations for example, the imaging module is attached to the venue infrastructure, and in some implementations, the imaging module is attached to a bracket, which is attached to the venue infrastructure. For example, motor or motors, belts, and pulleys can be used to act as moving mechanism. For example, the gear reduction can be implemented to increase torque 30×. For example, idlers can be implemented to keep belt engaged with pulley and constrained to pulley, e.g., strong correlation between pulley angle and pan angle. For example, only part of circular gear may be formed, e.g., which may be due to limited pan and tilt degree required to reduce footprint and provide additional mechanical safety stops. In some implementations, the disclosed technology includes a reduced movement range design, e.g., which can allow a smaller lens to have sufficient pan and tilting range as it clears the structure when panning and frame when tilting; for example, for a bigger sized lens (e.g., >10 inches), the range of movement can be reduced so that the imaging-device and lens do not contact the frame. For example, the pulleys can be configured to have a triangular shape to increase the force on the belt if driven past a certain pan or tilt range, e.g., which can cause the belts to break before the imaging-device or lens contacts the frame.

Exemplary Module

For example, the disclosed systems and methods can include one or more exemplary modules including the exemplary multiple-axis robotic mechanism, an exemplary housing of the image and/or video-capturing device, one or more lens(es), one or more motor(s), and/or other components, to implement any of a variety of functions. For example, the exemplary module can be monitored and controlled to operate the modules of the system. For example, the exemplary module can be calibrated and analyzed remotely. In some implementations, the exemplary module can include a driver, which controls the multiple-axis robotic mechanism movement, a microcontroller, a single board computer (SBC), which can save data and adjust the image and/or video-capturing device settings. In some implementations, the exemplary module can include an accelerometer, which can provide feedback movement information. For example, the driver or controller can also provide this movement feedback. In some implementations, batteries that can power the module/multiple-axis robotic mechanism can be continually charged to ensure no power lapses impact the calibration or ability to trigger the image and/or video-capture sequence, ensuring reliability. For example, both power and data connections can be hard-wired to the exemplary module.

Exemplary Image and/or Video-Capture Sequence

For example, the disclosed methods and systems can include one or more image and/or video-capturing device modules that can burst through a series of set positions at a high-speed acquiring the maximum amount of shots without affecting the image and/or video quality. For example, the series of images and videos can be captured at a speed of at least one image and/or video per second. The image and/or video-capturing device modules can capture the exemplary images and videos at pre-defined locations, e.g., which begins after being triggered. For example, the controller can be implemented to activate the exemplary image and/or video-capturing device modules' shutter. For example, the shutter can be triggered using software, a wired analog input or a hardware piece that depresses the shutter. For example, once the shutter is closed, this provides feedback that the image and/or video has been captured. This feedback can be sensed via a hotshoe, based on a timer from when the shutter was triggered or by software or an analog signal that highlights an image and/or video has been. There can also be feedback to and from the driver when the images and videos are taken and when the sequence is in activation. The controller then activates the multiple-axis robotic mechanism motors to move it to the next position. For example, this position can be pre-set with specific coordinates for the motors to drive it to with a high level of accuracy, e.g., below 0.5° in resolution on both the pan and tilt axis on the multiple-axis robotic mechanism. For example, if focus and zoom adjustments are required for the next set position, these can be triggered during the multiple-axis robotic mechanism movement periods. This can be triggered by software or hardware. Once the multiple-axis robotic mechanism has moved the image and/or video-capturing device to its next position and if the image and/or video-capturing devices automatic focus system is being used, e.g., either software or hardware, to semi-depress the shutter button, the auto-focusing period can start. This can begin before the image and/or video-capturing device has stabilized. For example, as the unit is stabilizing, a gyroscope can be used to counteract the vibration. Once the image and/or video-capturing device stabilizes, feedback can be given via a timer, e.g., started from when the movement was triggered. In some implementations, feedback can also or alternatively be given from an accelerometer, which measures when the movement has subsided. The driver or controller can also provide this movement feedback. For example, the image and/or video-capturing device shutter can then be triggered and again feedback that the shot has been taken as before. This can then be repeated and can continue through all of the pre-set sequence of shots through all of the pre-calibrated positions. At the end of the sequence, for example, the multiple-axis robotic mechanism can then move to a new specific, pre-calibrated starting position. For example, the multiple-axis robotic mechanism moves to a new position for the next moments capture. When the trigger is released, the SBC can also be triggered and can send an identification number to trigger a specific sequence store, the sequence execution logic. The controller can activate the shutter using an external trigger port, which can be a wired analog connection. The controller can also move the multiple-axis robotic mechanism. This exemplary sequence can be broken up into the initiation, which recalls the saved sequence movements and ensures the multiple-axis robotic mechanism is at the starting position, the execution, which is the movement and shooting sequence and the finalization, which finishes the movement and moves the multiple-axis robotic mechanisms to the next starting shoot position. The single board computer and driver communicate throughout this sequence process. For example, the system is able to trigger again after sequence compete, displayed when this available. For example, meta data can be assigned based on timing, e.g., the trigger time recorded to assign meta-data; image and/or video labeling time recorded to assign meta-data; and/or meta-data manually assigned to set of images and videos; as well as timing can be used to automatically assign meta-data to images and videos. In some implementations, for example, the one or more image and/or video capturing devices can be configured to include a predetermined focusing of the locations in the event venue.

Exemplary Positional and Image and/or Video-Capturing Device Calibration Methods

In some implementations, the disclosed technology includes methods for positional and image and/or video-capturing device calibration. For example, the image and/or video-capturing sequence can include specific, pre-defined positions for each shot as well as specific image and/or video-capturing device and lens settings. Each of the exemplary modules sequence logic can have specific image and/or video-capturing device positions, e.g., including a number of positions for each sequence and an alternating sequence per ‘moment’. For example, this information can be stored on each module, e.g., with the SBC housing this information, and/or the venue server. Each module and shot in a sequence may require different imaging parameters. For example, the exemplary image and/or video-capturing device's parameters are any adjustable parameter that alters the image and/or video captured, e.g., such as ISO, aperture, exposure, shutter speed, f-stop, depth of field, focus value, zoom on the lens, etc. For the device parameter data, this could either be pre-calibrated for each module or even each shot. In some implementations, this pre-calibration can occur manually, e.g., in which each shot position or sequence of shots has the devices' parameters identified, and these are stored on the SBC and/or the venue server and the remote server. This exemplary manual calibration can be suitable for indoor venues in which the lighting is set for each event. In other implementations, this pre-calibration can occur automatically, e.g., in which the image and/or video-capturing device parameters are automatically identified and stored for each image and/or video or sequence during a variety of times during the event. Implementations of the methods for positional and image and/or video-capturing device calibration can be performed just as the event begins, during a break in the event or directly after each time the modules have been triggered. For example, the parameter data, being continually recalibrated, priorities the previous data on the SBC and/or venue server and this is applied during the next imaging sequence. For example, this can be suitable for outdoor venues in which the light changes during the event, requiring the continual recalibration. For example, during activation of the module's image and/or video-capture sequence, as the image and/or video-capturing device is being moved to each position, imaging-parameter data can be applied for each shot or sequence. If the image and/or video-capturing device data is not pre-set, then, for example the system can rely on the image and/or video-capturing devices imaging sensor for particular parameters to be set for each image and/or video and this occurs during the sequence capture. In some examples, all data for multiple-axis robotic mechanism positioning and imaging data for each module are saved in the modules, and/or the venue server, and/or the remote server.

Exemplary Image and/or Video-Capturing Device Robotics Control Methods

In some implementations, the disclosed technology includes methods for image and/or video-capturing device robotics control. For example, exemplary system features, e.g., such as the lens zoom, focus value, and shutter activation, can be controlled manually using robotics, e.g., driving the focus and zoom values to pre-calibrated positions. In some examples, an electric motor, e.g., attached to the image and/or video-capturing device body or lens, can be implemented to rotate the motor shaft which can be connected to a pulley, which pulls a belt, that is connected the lens's rotating adjustable focus or zoom ring.

Exemplary Image and/or Video Transfer Software

The disclosed technology can include software to control the transferring of the captured images and videos from the exemplary image and/or video-capturing device to a server, e.g., to ultimately be processed and/or accessed by individuals. For example, the exemplary image and/or video transfer software can be implemented to monitor the image and/or video-capturing device for when the images and videos have been taken and stored. For example, when the image and/or video-capturing devices' images and videos are saved to a storage card, the SBC software can detect these, and they are pulled from the card. For example, these images and videos are then labeled and transferred to the venue server and then to the remote server. In some implementations, for example, an alternative method can include a process to tether the images and videos directly from the image and/or video-capturing device to the SBC or even venue server. In some implementations, for example, another alternative method can include a process to use the storage card or image and/or video-capturing device to upload the images and videos to a server either from a wired or wireless connection. For example, multiple versions of the images and videos can be captured by the image and/or video-capturing devices, e.g., a large RAW and a smaller JPEG file, among other examples. For example, any set of images and videos can also be compressed to reduce file size before uploaded to a user access server. In some examples, the smaller versions of the images and videos can be uploaded to the venue and/or remote servers faster than the larger ones, and the larger sized image and/or video files can be uploaded after the smaller sized files. Images and videos can be increased in quality for printing using automated image and/or video manipulation software. For example, a pre-set manipulation can be applied for each image and/or video or sets of images and videos, which can be to adjust pixels, repair focus, adjust the contrast, exposure, saturation etc.

Exemplary Image and/or Video Operation Software

The disclosed technology can include image and/or video operation and processing software. For example, the sequence of shots taken for each trigger/‘moment’ can produce a series of labeled images and videos, which can be grouped to be associated with that specific trigger number or ‘moment’. These exemplary groups can be sent to a server, e.g., venue based or remotely, so that they can be reviewed. The image and/or video group can then be approved at either the venue or remote server. For example, if approved, then any or all the images and videos in the group can be uploaded to the server accessed by the users. For example, if not approved or rejected, the image and/or video batch is not uploaded to the user accessible sever. The disclosed systems can also be set so that a time threshold controls the image and/or video uploading to the server. For example, if the time threshold is exceeded, then the group of images and videos can be upload to the server accessed by the users. For example, if the threshold is not exceeded, then the images and videos may remain in a pending mode and not uploaded to the user accessible server. The images and videos that have been uploaded to the user accessible server can also be removed by the whole group or individually. For example, a picture retention policy on the SBC and/or the event server can also be implemented. This exemplary policy can decide how to manage the limited storage available on these depositories. For example, this can be set to automatically remove the images and videos after they have been transferred to either the event server or remote server. Alternatively, for example, a set number or storage space worth of images and videos can be stored and then when the limit is reached the oldest ones start to delete. This can also be applied so that the images and videos are only stored for a set amount of time. The same above methods can also be implemented by saving the images and videos on another storage device.

Exemplary Location Identification Processing Methods

In some implementations, the disclosed technology includes methods for location identification processing. For example, calibration may be required for each installation once the image and/or video sequences are set. The method can include the following exemplary procedures. The image and/or video-capturing modules captures a series of images and videos. The images and videos are labeled with the specific venue, event, module number, moment number, and sequence number. Each image and/or video is then indexed or calibrated to the specific locations of individuals. In some examples, the dead space is removed from being calibrated or the specific crowd location is selected for calibration. A reference point area the size of individual seats or a specific crowd location area is set. These reference points are then iterated across the calibration area to identify the specific positions of individuals' locations or seats by using a function associated across the image and/or video. Each reference point placed is indexed to specific coordinates and will be assigned to reference points. The reference points placed can act as a focal point for centering the individual spectators, and each can have its own cropping radius surrounding it. A set cropping size surrounds and corresponds with its reference point. For example, these cropping radii iterate as the reference points iterate. When the newly cropped images and videos are processed they are labeled so that all of the corresponding reference points, and therefore locations/seats, are indexed to them. A smaller radius is also cropped and is also associated with each reference point and iterates as the reference points do, used as a thumbnail image and/or video so that users can scroll through each moment and see their specific reaction before selecting the image and/or video. The calibration is set so all of the image and/or video reference points, iterations, and the associated cropping is stored and assigned/indexed to locations. This exemplary processing can then be applied to specific images and videos taken during a live event at the venue. For example, all images and videos will have a specific processing which will apply the specific reference point iterations and cropping depending on the labeling of each image and/or video. Multiple images and videos can be created from the series of cropping applied, and these can be associated to the seating position allowing the user to recall their image and/or video. Location information, e.g., such as seat number, corresponds to the labeled ID, which identifies and allows access to the series of images and videos or they are sent to that specific user. One exemplary advantage of this method includes having all the processing and associations occur before the user recalls them, e.g., allowing for faster recall times and less stress on the servers. By identifying correlations between the images and videos with certain variables, e.g., such as the position area size, the angles associated with them and any patterns in dead space or calibration areas. These variables can be adjusted for each image and/or video and applied across all images and videos. In some implementations, for example, an alternative method of calibrating the cropping area position is to manually pinpoint the center of the cropping area and assigned each to the location/seating data. In some implementations, for example, an alternative method of processing the images and videos when captured is to dynamically crop them when the user requests their series of images and videos, in which the requests are queued and the images and videos are only cropped when requested. For example, as many individual images and videos are being taken of the venue, the spectators towards the edge of the images and videos will either receive a smaller cropped image and/or video or the images and videos being captured will overlap to reduce this effect. For example, depending on the users reference point, the cropped image and/or video is taken from the image and/or video with the most distance from the edge of the image and/or video. Also, for example, instead of seat location data being inputted from the user this could also be a unique code that is associated with the spectators' locations or in conjunction with geolocation data or Bluetooth/other wireless protocols from their mobile device. For example, when a user enters their event and location data this specific ID opens the specific image and/or video or set of images and videos. This exemplary processing could occur at the local (venue) or remote (cloud) server.

In some implementations, the forming of the processed image and/or video can include forming a segmented image and/or video. For example, the forming of the segmented image and/or video can include cropping at least one of the recorded images and videos to a size defined by the image and/or video space. Also for example, the forming of the segmented image and/or video can further include overlapping two or more of the recorded images and videos to form a merged image and/or video.

Exemplary Positioning Methods and Angles

Having specific vantage angles is one of the primary reasons why the disclosed systems can include modular units, e.g., which are placed in various strategic positions at the venue. In some examples, the placement of the exemplary modular units can be placed in an area in which, when the multiple-axis robotic mechanism of the module pans, the angles of images and videos taken of crowd particular sections (e.g., as in the example, sections 8 and 9) have an angle above 60° perpendicular to the plane of the crowd. For example, a vertical angle can be implemented—imaging device having an angle below 30°, perpendicular to the crowd's stand.

Exemplary Module Attachment Methods

In some implementations of the disclosed systems, the exemplary modules can be attached at the event venue via an exemplary cable attachment system. For example, a bracket, attached to venue infrastructure, can be used, which uses motors to lift or lower the cables attached to the module. For example, once the exemplary module is has been raised to fit to the bracket, both power and data connects through to the venue infrastructure. For example, to secure the module to the bracket clips, electromagnets, motor tension, etc. can be used. For example, the exemplary modules can also be attached to other infrastructure at the event venue based in the venue's center, e.g., such as jumbotrons, lighting platforms, etc.

Exemplary Wired-Platform

In some implementations of the disclosed systems, the exemplary modules can use a suspended platform held by wires over the center of the venue. In some examples, the platform would be held from at least 3 cables, e.g., to give it stability. To counteract any inertia, a counter balance can be added to each module, which moves in the opposite direction during movements to cancel out any force that would lead to platform shake. Alternatively, for example, movements of the exemplary module can be timed and set to move at the same time in opposite directions, so they act as the force counterbalance to prevent vibrations.

Exemplary Lighting System

Existing venue lighting system and have the lights synced with the trigger system so that they turn up for the duration of the sequence. For example, the exemplary lighting system can strobe when the modules are capturing each shot. In some examples, an alternative method can include addition of a new lighting system, which also pans and tilts as the image and/or video-capturing modules do, calibrated to be focusing the light on the subjects at the specific time of image and/or video capture for each section. For example, the exemplary lighting system can remain static, facing away from the crowd and focused on a pan and tilt mirror/reflective system that reflects the light beam onto the subjects.

Exemplary Monetization Choke Points Methods

Using the disclosed systems and methods, a user can be delivered or can access their images and videos from an event, in which a pre-constructed delivery or loading screen can display an image and/or video, video, or other advertising based information provided by the disclosed technology. For example, when the images and videos are ready to be viewed by the user, further advertisements can be displayed in the areas surrounding the images and videos. As each image and/or video is scrolled through, the advertisement displayed can also be adjusted to deliver a more dynamic and detailed message to the user. For example, specific meta-data about the event and moment can be added to the image and/or video. For example, in a sports event, this can be images and videos of the players involved in the moment, the teams playing logos, the scores, etc. When the image and/or video is pushed to an external social network or emailed, this meta-data is added to the actual image and/or video. For example, such advertisement or other monetization based data can include images and videos and text from brands. For example, such advertisement or other monetization based data can be specifically allocated to users based on user profile data, e.g., such as their sex, age, etc., to associate the most suitable branded message for each set of image and/or video recalls/access. For example, such advertisement or other monetization based data can also adjust depending on the events meta-data with prebuilt images and videos and rapid text changing during the event. For example, if the event was a high scoring soccer game the advertisement or other monetization based data could rapidly be adjusted to suit this game, e.g., discussing the high amount of goals or other factors of the event, etc. The assignment of the exemplary meta-data can be from/through a 3^{rd} party API call.

Exemplary Expiring, Concealed Promotion Systems and Methods

The disclosed technology includes systems and methods to provide an expiring and/or concealed promotion scheme to the users, e.g., which can be implemented concurrently with the image and/or video capturing, processing, and delivery methods of the users at moments during the event at the event venue. Exemplary methods of the expiring, concealed promotion technology can include the following exemplary processes. For example, the user can have a mobile application profile or a mobile sign-in profile, which can be used to identify which promotion information and associated notification is sent to that individual. Mobile geolocation or an event/location check-in identifies the users location, which is used to identify which promotion information and associated notification is sent to that individual. A notification about the hidden promotion can be sent to the users device. Each notification can display information to the user, which can relate to the content of the hidden promotion. For example, this could be a different level of notification such as gold, silver or bronze, which relates to the content benefit on the hidden promotion. For example, this notification information could also be information about the product or venue offering the promotion. The notifications can be sent to users at specific times. The notifications can be sent to a group of multiple users at the same time. The notifications can be sent sporadically, spaced out to individuals or groups of users over a set time period. The notification and associated promotion can also expire after a particular time period, e.g., in which this expiry time can be displayed in the notification. For example, when going to the promotion to see additional information, but without triggering the opening of it. The notification can be sent to the users and its associated information and promotion offered can be geolocation- and/or check-in location specific. When the user receives the promotion notification, information about the specific destination or location where the user is able to open it is displayed, either on the notification or associated with it, but without triggering its opening. This location/destination can vary for each user, time period, notification and promotion. For example, the user then can go to the location/destination to open the promotion to display its information to a verifier. This verifier can be a person that is acting as a vendor for the good; or a code that must be entered or scanned into the vendors system before it expires. For example, to activate the promotion for display it can either be pressed or held to show the information. This promotion can be configured to only be viewable for a specific period of time, before it expires and disappears/becomes redundant and can no longer be displayed and/or used. The exemplary promotion can be configured to only be opened once. In some implementations, for example, the promotion opening can be triggered just before the purchase occurs, during the purchase, or after an order for goods has been complete but before payment. In some implementations, for example, the promotion opening can be triggered after, e.g., when the goods have been paid for to receive a refund. The promotion and its associated notification and information can be randomly generated. The exemplary promotion sent can also be dependent on, or alter an exemplary random generating promotion algorithm, based on user information, such as their specific profile level. The exemplary promotion being displayed when opened can either be an image and/or video, text, a video or a combination of these. For example, the location of user is also identified when opening the promotion to adjust the information if they are in the vicinity of the promotion collection vendor or not.

In some examples, a promotion can include money off a specific good, free goods etc., e.g., for individuals as well as multiple people through one profile. Instead of a promotion, which offers an economic benefit to the users, for example, the promotion can be replaced with other information such as images and videos, texts or videos which have an expiring time period and again can only be opened and viewed once for a set period of time. For example, the users location can also be regularly tracked to push unique notifications and promotions to users that are not regularly in that area, to entice new customers. The users of the app can also connect to their friends, family and colleagues via their phone numbers or social network connections. For example, this allows the notifications and promotions to be sent to multiple people when they are within a certain range of each other. For example, this can be to be people that are in the physical company of each other, showing the same geolocation data, and either the same promotion or varied promotions can be sent to each person but all at the same time.

In some examples, an exemplary promotion can be sent to just one person in a group, known from geolocation and group connections, with information about the promotion being for multiple people and even the specific people in close proximity that could benefit from the promotion. It can also be for users who have connections within a range, but not in the physical company of each other. For example, this vendor could also be any venue or service, selling a variety of goods such as meals, drinks, groceries, clothing, hotels, electronic items, transportation, entertainment products etc. The venue can set a series of promotions of what to offer and the quantity of each promotion offered, such as money off tickets or merchandise. The venue also can set the time the promotions are sent, the time the promotions will be valid for, and the amount of time they can be viewed once opened. For example, the promotions can also adjust, with their message depending on what is happening in the game.

Various implementations, embodiments and examples have been described in this patent document for illustrative purposes without limitations. For example, recitations of an image “and/or” video is meant to describe an alternate list that includes an image or a video or an image and a video. Similarly, recitations of image and/or video and a sequence of image and/or video include, but not limited to, a still image, a sequence of still images, a sequence of images in a video, a video, a sequence of videos, both an image and a video, both a sequence of images and a video, both an image and a sequence of videos or both a sequence of images and a sequence of videos. Similarly, image and/or video location include, but not limited to, a location of each image, a location of each image in a sequence of image, a location of a sequence of images, a location of a video, a location of each video in a sequence of videos, a location of a sequence of videos, a location of an image and a video, a location of a sequence of images and a video, a location of an image and a sequence of videos, or a location of a sequence of images and a sequence of videos.

Implementations of the subject matter and the functional operations described in this patent document can be implemented in various systems, digital electronic circuitry, or in computer software, firmware, or hardware, including the structures disclosed in this specification and their structural equivalents, or in combinations of one or more of them. Implementations of the subject matter described in this specification can be implemented as one or more computer program products, e.g., one or more modules of computer program instructions encoded on a tangible and non-transitory computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of nonvolatile memory, media and memory devices, including by way of example semiconductor memory devices, e.g., EPROM, EEPROM, and flash memory devices. The processor and the memory can be supplemented by, or incorporated in, special purpose logic circuitry.

While this patent document contains many specifics, these should not be construed as limitations on the scope of any invention or of what may be claimed, but rather as descriptions of features that may be specific to particular embodiments of particular inventions. Certain features that are described in this patent document in the context of separate embodiment, can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described in this patent document should not be understood as requiring such separation in all embodiments.

Only a few implementations and examples are described and other implementations, enhancements and variations can be made based on what is described and illustrated in this patent document.

What is claimed are techniques and structures as described and shown, including:

1. An imaging service system, comprising:
image and/or video capture devices arranged in an event venue, at least one of the image and/or video capture devices configured to capture images and/or videos of locations in the event venue responsive to a triggering signal received during an event, wherein the captured images and/or videos include one or more attendees at the event;
a trigger device communicatively coupled to the image and/or video capture devices to:
detect an occurrence of a moment during the event that satisfies a threshold, and
responsive to the detected occurrence of the moment, send the triggering signal to at least one of the image and/or video capture devices to initiate capture of the images and/or videos; and
one or more computers in communication with the image and/or video capture devices to process the captured images and/or videos received from the at least one image and/or video capture device to determine coordinates associated with the captured images and/or videos that correspond to the locations in the event venue and to generate a processed image and/or video based on the determined coordinates centered on the corresponding location in the event venue,
wherein the locations in the event venue for capturing the images and/or videos are predetermined.

2. The system of claim 1, wherein at least one of the image and/or video capture devices includes:
a camera;
one or more motors coupled to the camera to adjust mechanical positions of the camera, and
one or more control modules communicatively coupled to the one or more motors to provide control signals to the one or more motors.

3. The system of claim 2, wherein the trigger device is configured to process feedback from at least one of the camera or the one or more motors.

4. The system of claim 1, wherein the at least one image and/or video capture device is configured to initiate a sequence of image and/or video capture responsive to the triggering signal.

5. The system of claim 1, wherein the attendees include fans or spectators at a sporting event.

6. The system of claim 1, wherein the locations correspond to labeled seating in the event venue.

7. The system of claim 1, wherein the image and/or video capture devices are arranged in the event venue to capture the images and/or videos of the attendees from multiple directions.

8. The system of claim 1, wherein the image and/or video capture devices are configured to capture a sequence of images and/or videos of the attendees during predetermined time period.

9. The system of claim 1, wherein the trigger device includes one or more manual trigger mechanisms configured to be operated by one or more operators to send the triggering signal to capture the images and videos.

10. The system of claim 1, wherein the trigger device includes at least one automatic trigger mechanism configured to detect a trigger stimulus including at least one of a sound, a decibel level, or a mechanical perturbation, and based on the detected trigger stimulus satisfying a respective threshold, send the triggering signal to capture the images and/or videos.

11. The system of claim 1, wherein the one or more computers are configured to process the captured images and/or videos to generate processed images and/or videos of at least one of the attendees based on the determined coordinates corresponding to the at least one attendee.

12. The system of claim 11, wherein the one or more computers are configured distribute the generated processed images and/or videos of the at least one of the attendees to a mobile device of the corresponding at least one of the attendees based on information obtained from the corresponding at least one of the attendees.

13. The system of claim 11, wherein the one or more computers are configured to upload the generated processed images and/or videos of the corresponding at least one of the attendees' user profile associated with a social network.

14. The system of claim 11, wherein the one or more computers are configured to present the generated processed images and/or videos of the corresponding at least one of the attendees for purchase on a kiosk.

15. The system of claim 1, wherein the one or more computers are communicatively coupled to a security system to determine a security-related incident based on the processed images and/or videos.

16. A method for capturing an image and/or video of an event in an event venue for distribution, the method comprising:
capturing, by image and/or video capture devices, a sequence of images and/or videos of locations in the event venue responsive to a triggering signal received during the event, wherein the sequence of images include at least one of the attendees;
assigning labeling information to the captured sequence of images and/or videos;
processing the labeling information assigned sequence of images and/or videos at one or more computers in communication with the image and/or video capture devices, the processing includes:
mapping, based on the labeling information, the locations to a grid corresponding to predetermined physical locations associated with the event venue to determine coordinates associated with the captured sequence of images and/or videos that correspond to the mapped locations in the event venue,
determining an image and/or video space containing the at least one of the attendees at a particular location in the event venue based on the coordinates,
generating processed images and/or videos based on the determined image and/or video space, and
associating meta-data with the generated processed images and/or videos, the meta-data including information representing a moment during the event that generated the triggering signal; and
distributing the processed images and/or videos to the at least one attendee.

17. The method of claim 16, wherein the predetermined physical positions include at least one of labeled seating in the event venue or location data of the attendees.

18. The method of claim 16, comprising:
manually generating the triggering signal based on an operator detected moment that satisfies a threshold.

19. The method of claim 16, comprising:
automatically generating the triggering signal based on detection of a sound or mechanical perturbation at the event venue that satisfies a threshold.

20. The method of claim 16, wherein the sequence of images and/or videos are captured at a speed of at least two images per second.

21. The method of claim 16, wherein capturing the sequence of images and/or videos include applying a predetermined focus at the locations in the event venue.

22. The method of claim 16, wherein generating the processed images and/or videos includes producing a segmented image by cropping at least one of the captured images to a size defined by the image and/or video space.

23. The method of claim 22, wherein the producing the segmented image includes compensating for overlapping of two or more of the captured images.

24. The method of claim 16, comprising:
presenting a graphical user interface on a mobile device associated with the at least one of the attendee to present the processed images and/or videos of the corresponding at least one of the attendees.

25. The method of claim 16, further comprising:
prior to the processing, reviewing the sequence of images and/or videos for at least one of positional calibration, image and/or video quality, or attendee reaction quality; and
approving at least one of the reviewed images and/or videos.

26. The method of claim 16, wherein the labeling information assigned to the images and/or videos of the captured sequence includes a label identifier corresponding to one or more of the following: an identification of the event venue, an identification of the event, an identification of the one or more image and/or video capturing devices, an identification of the moment that generated the triggering signal, and a sequence number of the images of the sequence of images and/or videos.

27. The method of claim 16, comprising:
prior to the event, capturing a sequence of reference images and/or videos of at least a section of the event venue locations using the image and/or video capturing devices positioned in the event venue;
assigning a reference label to each reference image and/or video of the sequence of reference images and/or videos; and
generating a reference image and/or video coordinate space in each of the reference images and videos by mapping reference image and/or video location areas of the captured sequence of reference images and/or videos to corresponding physical locations of the event venue.

28. The method of claim 27, comprising:
generating image and/or video template data for each of the image and/or video location areas associated with each of the reference images and/or videos, the image and/or video template data based on at least a portion of the reference image and/or video coordinate space substantially centered on respective image and/or video location area.

29. The method of claim 28, wherein processing the labeling information assigned sequence of images and/or videos include:
for a given labeling information assigned image and/or video, obtaining the image and/or video template data of the corresponding reference image and/or video based on the labeling information; and
generating the processed image and/or video for the given labeling information assigned image and/or video based on the reference video template data; and
distributing the processed image and/or video to at least some of the attendees based on location information of the corresponding at least one attendee obtained from the labeling information.

30. The method of claim 16, wherein the physical locations of the event venue in the reference images and/or videos include labeled seating in the event venue.

31. A method of providing a promotion offer to a mobile device associated with an attendee at an event venue during an event, the method comprising:
identifying a physical location of the attendee at the event venue using location data received from at least one of the mobile device associated with the attendee or a check-in site at the event venue that received user input from the attendee;
sending a notification to the mobile device associated with the attendee including the promotion offer from a vendor at a vendor location based on the identified physical location of the attendee, wherein the promotion offer included in the notification is sent to the mobile device inactive and contents of the inactive promotion offer is concealed until activated; and
revealing the concealed contents of the promotion offer by displaying the contents on the mobile device associated with the attendee responsive to receiving input activating the promotion offer;
wherein the promotion offer is configured to have a limited time period of availability after activation.

32. The method of claim 31, wherein the notification includes:
information identifying the vendor and vendor location; and
instructions to the attendee to activate the promotion offer at or near the vendor location.

33. The method of claim 32, wherein revealing the contents of the promotion offer includes receiving the input activating the promotion offer and identifying the physical location of the attendee as being at or near the vendor location.

34. The method of claim 32, wherein identifying the physical location of the attendee as being at or near the vendor location includes receiving a verification by the vendor indicating that the attendee is at or near the vendor location.

35. The method of claim 31, wherein revealing the concealed contents of the promotion is performed exactly one time for a predetermine period of time responsive to the input activating the promotion offer.

36. The method of claim 31, wherein the concealed contents of the promotion offer include at least one of an image, video, text, or video.

37. The method of claim 31, wherein the concealed contents of the promotion offer include at least one of a price discount on the future purchase, a free product, a free service, or a charitable donation by the vendor with the future purchase.

38. The method of claim 31, wherein the notification with the promotion offer is sent during the event corresponding to a specific occurrence of a moment.

39. The method of claim 31, wherein the concealed contents of the promotion offer is randomly selected.

40. The method of claim 31, wherein the concealed contents of the promotion offer is selected based on attendee preference information.

41. The method of claim 31, comprising:
preventing redemption of the promotion offer until receiving verification of the revealed promotion offer.

42. The method of claim 41, wherein the received verification includes information received from the vendor.

43. A method of integrating media content with attendee content at an event venue during an event, the method comprising:
responsive to a triggering signal associated a triggering moment during the event, capturing a video and/or Graphics interchange Format (gif) image of attendees at the event during the triggering moment and a video and/or gif image of the triggering moment that the attendees are reacting to, the videos and gif images are captured from image and/or video capture devices selectively arranged in the event venue;
obtaining data associated with the triggering moment during the event; and
auto-creating media content that combines the captured videos and/or gif images of the attendees and the triggering moment with the obtained data associated with the triggering moment.

44. The method of claim 43, wherein capturing the videos and/or gif images are operator controlled.

45. The method of claim 43, comprising:
distributing the auto-created content to at least one of the attendees.
